(19) United States
(12) Patent Application Publication
(10) Pub. No.: US 2026/0052354 A1
(43) Pub. Date: Feb. 19, 2026

(54) METHOD AND SYSTEM OF MULTI-MODAL TRACKING FOR DYNAMIC SPATIAL AUDIO RENDERING

(71) Applicant: QUALCOMM Incorporated, San Diego, CA (US)

(72) Inventors: Graham Bradley DAVIS, Seattle, WA (US); Shankar THAGADUR SHIVAPPA, San Diego, CA (US); Andrea Felice GENOVESE, Brooklyn, NY (US); Michel Adib SARKIS, San Diego, CA (US); Matthew FISCHLER, San Diego, CA (US); Fawad SHAUKAT, San Diego, CA (US); Tinsaye Yitbarek SUME, San Diego, CA (US); Pin-Yen HUANG, Zhubei City (TW)

(21) Appl. No.: 19/297,764

(22) Filed: Aug. 12, 2025

Related U.S. Application Data
(60) Provisional application No. 63/684,114, filed on Aug. 16, 2024.

(51) Int. Cl. H04S 7/00

(52) U.S. Cl. CPC H04S 7/304; H04S 2400/01; H04S 2400/11

(57) ABSTRACT

A device includes a memory configured to store multi-channel audio content. The device also includes one or more processors coupled to the memory and configured to obtain first information based on first sensor data from a first sensor and to obtain second information based on second sensor data from a second sensor. The one or more processors are further configured to select, based on the first information, the second information, or a combination thereof, a determination scheme. The one or more processors are configured to generate, based on the determination scheme, determination information associated with an audio output device. The determination information indicates an orientation, a position, or a combination thereof. The one or more processors are configured to generate, based on the determination information and the multi-channel audio content, a spatial audio output associated with the audio output device.

### 1. CROSS-REFERENCE TO RELATED APPLICATIONS

The present application claims priority from the commonly owned U.S. Provisional Patent Application No. 63/684,114, filed Aug. 16, 2024, entitled “METHOD AND SYSTEM OF MULTI-MODAL TRACKING FOR DYNAMIC SPATIAL AUDIO RENDERING”, the content of which is incorporated herein by reference in its entirety.

### II. FIELD

The present disclosure is generally related to generating a spatial audio output.

### III. DESCRIPTION OF RELATED ART

Advances in technology have resulted in smaller and more powerful computing devices. For example, there currently exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Dynamic binaural synthesis requires accurate six degrees of freedom (DoF) tracking of a user to effectively reproduce an adjusted sound field based on a pose (e.g., an orientation and a position) of a user. For mobile, computer, and television (TV) use cases (e.g., media consumption, gaming, or teleconferencing), six DoF rendering systems track the pose (e.g., orientation and position) of the user relative to a source device. Conventional systems typically rely on specialized hardware or data communication protocols to track the pose of the user, particularly in systems that include separate source devices (e.g., devices that generate spatialized audio) and user devices (e.g., devices that output the spatialized audio to the user). For example, conventional mobile and computer systems often use inertial measurement unit (IMU)-based head-tracking to track orientation. However, these systems do not support six DoF audio rendering (i.e., they do not have an indication of position) and require specialized hardware for the source device and the user device. These systems also have a two-way roundtrip motion-to-sound (M2S)-latency associated with head-tracking on the user device, audio rendering on the source device, and playback on user device. As another example of conventional tracking for spatialized audio generation, conventional virtual reality (VR) systems often use complicated systems of internal/external sensors for six DoF tracking. Some such VR systems use lighthouse tracking which utilizes a collection of expensive external base stations to track a sensor attached to a user. Other VR systems use inside-out tracking which utilizes numerous sensors on a user-worn device to track external anchor points and estimate a relative pose (e.g., a relative position or a relative orientation) of the user. Such inside-out tracking systems typically do not provide six DoF tracking data to an external source device, making dynamic binaural synthesis of spatialized audio for such devices challenging.

### IV. SUMMARY

According to one aspect of the present disclosure, a device includes a memory configured to store multi-channel audio content. The device also includes one or more processors configured to obtain first information based on first sensor data from a first sensor and obtain second information based on second sensor data from a second sensor. The one or more processors are further configured to select, based on the first information, the second information, or a combination thereof, a determination scheme. The one or more processors are also configured to generate, based on the determination scheme, determination information associated with an audio output device. The determination information indicates an orientation, a position, or a combination thereof. The one or more processors are also configured to generate, based on the determination information and the multi-channel audio content, a spatial audio output associated with the audio output device.

According to another aspect of the present disclosure, a method of operating a processor of an audio device is disclosed. The method includes obtaining first information based on first sensor data from a first sensor and obtaining second information based on second sensor data from a second sensor. The method also includes selecting, based on the first information, the second information, or a combination thereof, a determination scheme. The method further includes generating, based on the determination scheme, determination information associated with an audio output device. The determination information indicates an orientation, a position, or a combination thereof. The method includes generating, based on the determination information and multi-channel audio content, a spatial audio output associated with the audio output device.

According to another aspect of the present disclosure, a non-transitory computer-readable medium stores instructions that are executable by one or more processors to cause the one or more processors to obtain first information based on first sensor data from a first sensor and to obtain second information based on second sensor data from a second sensor. The instructions are further executable to cause the one or more processors to select, based on the first information, the second information, or a combination thereof, a determination scheme. The instructions are also executable to cause the one or more processors to generate, based on the determination scheme, determination information associated with an audio output device. The determination information indicates an orientation, a position, or a combination thereof. The instructions are also executable to cause the one or more processors to generate, based on the determination information and multi-channel audio content, a spatial audio output associated with the audio output device.

According to another aspect of the present disclosure, an apparatus includes means for obtaining first information based on first sensor data from a first sensor and means for obtaining second information based on second sensor data from a second sensor. The apparatus also includes means for selecting, based on the first information, the second information, or a combination thereof, a determination scheme. The apparatus also includes means for generating, based on the determination scheme, determination information associated with an audio output device. The determination information indicates an orientation, a position, or a combination thereof. The apparatus includes means for generating, based on the determination information and multi-channel audio content, a spatial audio output associated with the audio output device.

Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a block diagram of particular aspects of a system that includes a device operable to generate spatial audio, in accordance with some examples of the present disclosure.

FIG. 2 is a block diagram of an example of a system that includes a device operable to generate spatial audio, in accordance with some examples of the present disclosure.

FIG. 3 is a diagram of an example of a system that includes an integrated circuit operable to generate spatial audio, in accordance with some examples of the present disclosure.

FIG. 4 is a diagram of an illustrative aspect of a system that includes a mobile device operable to generate spatial audio, in accordance with some examples of the present disclosure.

FIG. 5 is a diagram of an illustrative aspect of a system that includes a wearable device operable to generate spatial audio, in accordance with some examples of the present disclosure.

FIG. 6 is a diagram of an illustrative aspect of a system that includes a vehicle operable to generate spatial audio, in accordance with some examples of the present disclosure.

FIG. 7 is a diagram of a particular illustrative example of a method of generating spatial audio content, in accordance with some examples of the present disclosure.

FIG. 8 is a block diagram of a particular illustrative example of a device that is operable to generate spatial audio, in accordance with some examples of the present disclosure.

### VI. DETAILED DESCRIPTION

Aspects disclosed herein enable a source device that performs multi-modal sensor fusion to combine computer vision (CV) algorithm(s) (e.g., data generated by the CV algorithm(s)) and other sensor data, such as inertial measurement unit (IMU)-based orientation information of the source device and/or IMU-based orientation information of an audio output device, for accurate six degrees of freedom (DoF) tracking of a relative position and a relative orientation of a user for dynamic spatial audio rendering associated with the user or an audio output device of the user. For example, the source device may include a camera that enables the source device to determine a relative position estimation (associated with the user) in addition to an orientation estimation. Additionally, the source device may include an IMU that is used to indicate an orientation of the source device and/or the audio output device may include an IMU that is used to indicate an orientation of the audio output device. In some aspects, the CV algorithm(s) can also be used for multi-user tracking to enable the source device to render spatial audio for multiple different users. The multi-modal sensor fusion may not require specialized hardware on either the source device or the audio output device of the user. Additionally, or alternatively, the multi-modal sensor fusion may not require orientation data communication between the source device and the audio playback device of the user—e.g., all relative six DoF tracking and audio rendering can be performed at the source device. In some examples, the source device dynamically selects one or more sensor inputs to use to determine a relative pose (with respect to the source device) of a user, thereby providing flexibility to select the appropriate sensor data for various conditions. Accordingly, the multi-modal sensor fusion, using computer CV data and optional IMU data (e.g., IMU data from an IMU of the source device and/or IMU data from the audio output device), can improve quality and stability of user tracking by the source device and therefore improve a quality of spatial audio rendering provided to the audio output device of the user.

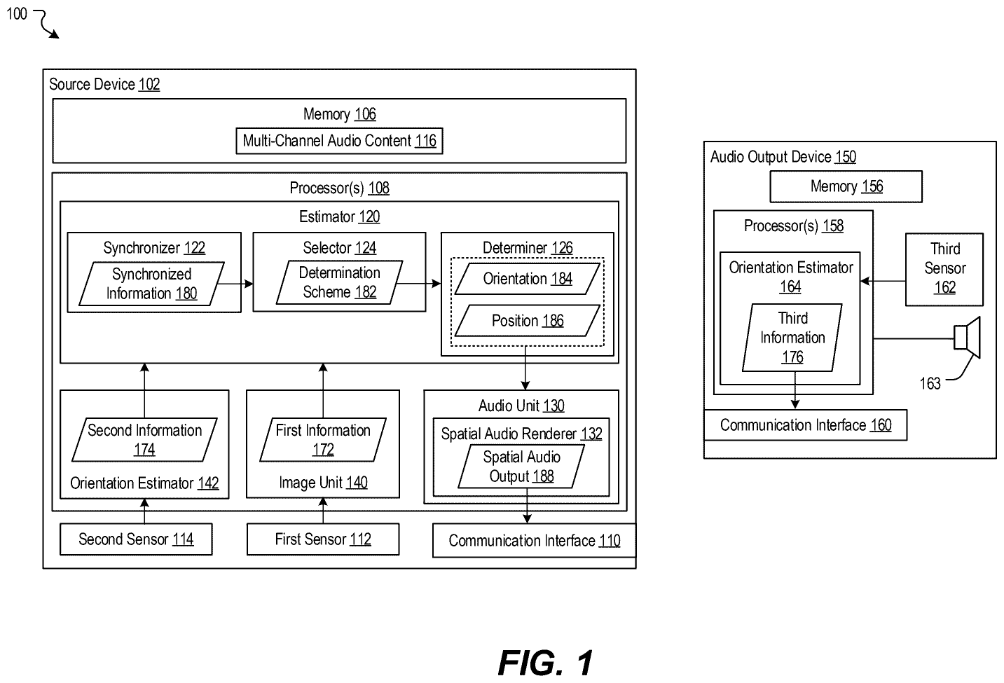

Particular aspects of the present disclosure are described below with reference to the drawings. In the description, common features are designated by common reference numbers. As used herein, various terminology is used for the purpose of describing particular examples only and is not intended to be limiting of other examples. For example, the singular forms “a,” “an,” and “the” are intended to include the plural forms as well, unless the context clearly indicates otherwise. Further, some features described herein are singular in some examples and plural in other examples. To illustrate, FIG. 1 depicts a source device 102 including one or more processors (“processor(s)” 108 of FIG. 1), which indicates that in some examples the source device 102 includes a single processor 108 and in other examples the source device 102 includes multiple processors 108. For ease of reference herein, such features are generally introduced as “one or more” features and are subsequently referred to in the singular or optional plural (as indicated by “(s)”) unless aspects related to multiple of the features are being described.

In some drawings, multiple instances of a particular type of feature are used. Although these features are physically and/or logically distinct, the same reference number is used for each, and the different instances are distinguished by addition of a letter to the reference number. When the features as a group or a type are referred to herein e.g., when no particular one of the features is being referenced, the reference number is used without a distinguishing letter. However, when one particular feature of multiple features of the same type is referred to herein, the reference number is used with the distinguishing letter.

As used herein, the terms “comprise,” “comprises,” and “comprising” may be used interchangeably with “include,” “includes,” or “including.” Additionally, the term “wherein” may be used interchangeably with “where.” As used herein, “exemplary” indicates an example, an implementation, and/or an aspect, and should not be construed as limiting or as indicating a preference or a preferred implementation. As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “set” refers to one or more of a particular element, and the term “plurality” refers to multiple (e.g., two or more) of a particular element.

As used herein, “coupled” may include “communicatively coupled,” “electrically coupled,” or “physically coupled,” and may also (or alternatively) include any combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some examples, two devices (or components) that are communicatively coupled, such as in electrical communication, may send and receive signals (e.g., digital signals or analog signals) directly or indirectly, via one or more wires, buses, networks, etc. As used herein, “directly coupled” may include two devices that are coupled (e.g., communicatively coupled, electrically coupled, or physically coupled) without intervening components.

In the present disclosure, terms such as “determining,” “calculating,” “estimating,” “shifting,” “adjusting,” etc. may be used to describe how one or more operations are performed. It should be noted that such terms are not to be construed as limiting and other techniques may be utilized to perform similar operations. Additionally, as referred to herein, “obtaining,” “generating,” “calculating,” “estimating,” “using,” “selecting,” “accessing,” and “determining” may be used interchangeably. For example, “obtaining,” “generating,” “calculating,” “estimating,” or “determining” a parameter (or a signal) may refer to actively generating, estimating, calculating, or determining the parameter (or the signal) or may refer to using, selecting, or accessing the parameter (or signal) that is already generated, such as by another component or device.

As used herein, the term “machine learning” should be understood to have any of its usual and customary meanings within the fields of computers science and data science, such meanings including, for example, processes or techniques by which one or more computers can learn to perform some operation or function without being explicitly programmed to do so. As a typical example, machine learning can be used to enable one or more computers to analyze data to identify patterns in data and generate a result based on the analysis. For certain types of machine learning, the results that are generated include data that indicates an underlying structure or pattern of the data itself. Such techniques, for example, include so called “clustering” techniques, which identify clusters (e.g., groupings of data elements of the data).

For certain types of machine learning, the results that are generated include a data model (also referred to as a “machine-learning model” or simply a “model”). Typically, a model is generated using a first data set to facilitate analysis of a second data set. For example, a first portion of a large body of data may be used to generate a model that can be used to analyze the remaining portion of the large body of data. As another example, a set of historical data can be used to generate a model that can be used to analyze future data.

Since a model can be used to evaluate a set of data that is distinct from the data used to generate the model, the model can be viewed as a type of software (e.g., instructions, parameters, or both) that is automatically generated by the computer(s) during the machine learning process. As such, the model can be portable (e.g., can be generated at a first computer, and subsequently moved to a second computer for further training, for use, or both). Additionally, a model can be used in combination with one or more other models to perform a desired analysis. To illustrate, first data can be provided as input to a first model to generate first model output data, which can be provided (alone, with the first data, or with other data) as input to a second model to generate second model output data indicating a result of a desired analysis. Depending on the analysis and data involved, different combinations of models may be used to generate such results. In some examples, multiple models may provide model output that is input to a single model. In some examples, a single model provides model output to multiple models as input.

Examples of machine-learning models include, without limitation, perceptrons, neural networks, support vector machines, regression models, decision trees, Bayesian models, Boltzmann machines, adaptive neuro-fuzzy inference systems, as well as combinations, ensembles and variants of these and other types of models. Variants of neural networks include, for example and without limitation, prototypical networks, autoencoders, transformers, self-attention networks, convolutional neural networks, deep neural networks, deep belief networks, etc. Variants of decision trees include, for example and without limitation, random forests, boosted decision trees, etc.

Since machine-learning models are generated by computer(s) based on input data, machine-learning models can be discussed in terms of at least two distinct time windows—a creation/training phase and a runtime phase. During the creation/training phase, a model is created, trained, adapted, validated, or otherwise configured by the computer based on the input data (which in the creation/training phase, is generally referred to as “training data”). Note that the trained model corresponds to software that has been generated and/or refined during the creation/training phase to perform particular operations, such as classification, prediction, encoding, or other data analysis or data synthesis operations. During the runtime phase (or “inference” phase), the model is used to analyze input data to generate model output. The content of the model output depends on the type of model. For example, a model can be trained to perform classification tasks or regression tasks, as non-limiting examples. In some implementations, a model may be continuously, periodically, or occasionally updated, in which case training time and runtime may be interleaved or one version of the model can be used for inference while a copy is updated, after which the updated copy may be deployed for inference.

In some implementations, a previously generated model is trained (or re-trained) using a machine-learning technique. In this context, “training” refers to adapting the model or parameters of the model to a particular data set. Unless otherwise clear from the specific context, the term “training” as used herein includes “re-training” or refining a model for a specific data set. For example, training may include so called “transfer learning.” In transfer learning a base model may be trained using a generic or typical data set, and the base model may be subsequently refined (e.g., re-trained or further trained) using a more specific data set.

A data set used during training is referred to as a “training data set” or simply “training data”. The data set may be labeled or unlabeled. “Labeled data” refers to data that has been assigned a categorical label indicating a group or category with which the data is associated, and “unlabeled data” refers to data that is not labeled. Typically, “supervised machine-learning processes” use labeled data to train a machine-learning model, and “unsupervised machine-learning processes” use unlabeled data to train a machine-learning model; however, it should be understood that a label associated with data is itself merely another data element that can be used in any appropriate machine-learning process. To illustrate, many clustering operations can operate using unlabeled data; however, such a clustering operation can use labeled data by ignoring labels assigned to data or by treating the labels the same as other data elements.

Training a model based on a training data set generally involves changing parameters of the model with a goal of causing the output of the model to have particular characteristics based on data input to the model. To distinguish from model generation operations, model training may be referred to herein as optimization or optimization training. In this context, “optimization” refers to improving a metric, and does not mean finding an ideal (e.g., global maximum or global minimum) value of the metric. Examples of optimization trainers include, without limitation, backpropagation trainers, derivative free optimizers (DFOs), and extreme learning machines (ELMs). As one example of training a model, during supervised training of a neural network, an input data sample is associated with a label. When the input data sample is provided to the model, the model generates output data, which is compared to the label associated with the input data sample to generate an error value. Parameters of the model are modified in an attempt to reduce (e.g., optimize) the error value. As another example of training a model, during unsupervised training of an autoencoder, a data sample is provided as input to the autoencoder, and the autoencoder reduces the dimensionality of the data sample (which is a lossy operation) and attempts to reconstruct the data sample as output data. In this example, the output data is compared to the input data sample to generate a reconstruction loss, and parameters of the autoencoder are modified in an attempt to reduce (e.g., optimize) the reconstruction loss.

FIG. 1 is a block diagram of particular aspects of a system 100 that includes a device 102 (also referred to herein as a “source device 102”) operable to generate spatial audio, in accordance with some examples of the present disclosure. The source device 102 may include a spatial audio rendering device, such as a portable device, a wearable device, a vehicle, or a television, as illustrative, non-limiting examples. The system 100 also includes an audio output device 150 that is configured to output the spatial audio generated by the source device 102.

The source device 102 includes a memory 106, one or more processors 108 (collectively referred to herein as a “processor 108”), a communication interface 110, and one or more sensors. For example, the one or more sensors may include a first sensor 112 and a second sensor 114. In some examples, the first sensor 112 is or includes an image capture device (e.g., a camera) and the second sensor 114 is or includes an inertial measurement unit (IMU). Although the one or more sensors are described as being included in the source device 102, in other examples, at least one sensor may be remotely positioned or otherwise coupled to the source device 102. For example, the first sensor 112 or another sensor (e.g., a camera) may be remotely positioned or external to the source device 102 and coupled to the source device 102.

The memory 106 is configured to store multi-channel audio content 116. The multi-channel audio content 116 can include or indicate audio content that is to be used to render spatial audio content. In some examples, the memory 106 further includes or stores instructions that, when executed by the processor 108, cause the processor 108 to perform one or more operations as described herein. In some examples, the memory 106 stores other information or data, such as location information of a physical location of the source device 102, user identity (ID) information associated with one or more users of the source device 102 or the audio output device 150, determination scheme information associated with one or more determination schemes for determining pose data, a model (e.g., a trained machine learning model) for generating a determination scheme, one or more thresholds, or a combination thereof, as illustrative, non-limiting examples.

The communication interface 110 is coupled to one or more components of the source device 102. For example, the communication interface 110 may be coupled to the memory 106, the processor 108, or a combination thereof. In some examples, the communication interface 110 includes a Bluetooth (BT) interface, such as a BT advanced audio distribution profile (A2DP) interface, a BT human interface device (HID) interface, or a combination thereof. In other examples, the communication interface 110 includes a Wi-Fi interface, an IEEE 802.11 interface, a Zigbee interface, or another type of wireless interface.

The processor 108 includes an estimator 120, an audio unit 130, an image unit 140, and an orientation estimator 142. Each of the estimator 120, the audio unit 130, the image unit 140, the orientation estimator 142, or a portion thereof, may be implemented by the processor 108 executing instructions (e.g., software), dedicated hardware (e.g., circuitry), a combination thereof.

The image unit 140 is configured to receive first data (e.g., image data) from the first sensor 112 and to perform one or more image processing operations on the first data to generate first information 172. For example, the first sensor 112 (e.g., the camera) may be configured to capture one or more images of a user of the audio output device 150, and the image unit 140 may perform one or more image processing operations on image data output by the first sensor 112 that represents the images of the user. The one or more image processing operations may include or be associated with one or more computer vision (CV) algorithms and may include user detection operations, face detection operations, user tracking operations, or a combination thereof. In some examples, the first information 172 may include or indicate an orientation of a user (of the audio output device 150), a position of the user, metadata associated with the one or more image processing operations, a sensor ID of the first sensor 112, or a combination thereof. The orientation of the user may include a direction (e.g., North, South, East, or West), an angular position, a rotation of an axis (e.g., an x-, y-, or z-axis), or a combination thereof, as illustrative, non-limiting examples. Additionally, or alternatively, the orientation of the user may be a relative orientation or an absolute orientation. The position of the user may include or be associated with a set of coordinates (x, y, z), global navigation satellite system (GNSS) data, latitude and longitude, or a combination thereof, as illustrative, non-limiting examples. Additionally, or alternatively, the position of the user may be a relative position or an absolute position. The metadata may include or indicate a bounding box, a facial confidence score, a match confidence score, image quality values, or a combination thereof, as illustrative, non-limiting examples.

The orientation estimator 142 is configured to receive second data (e.g., IMU data) from the second sensor 114. The orientation estimator 142 may determine second information 174 based on the second data. For example, the second sensor 114 may track motion of the source device 102, and the orientation estimator 142 may determine the second information 174 based on motion data (e.g., the second data) output by the second sensor 114. The second information 174 may include or indicate an orientation of the source device 102, a sensor ID of the second sensor 114, or a combination thereof. The orientation of the source device 102 may include a direction (e.g., North, South, East, or West), an angular position, a rotation of an axis (e.g., an x-, y-, or z-axis), or a combination thereof, as illustrative, non-limiting examples.

The estimator 120 includes a synchronizer 122, a selector 124, and a determiner 126. The synchronizer 122 is configured to receive information generated based on sensor data for one or more sensors. For example, the synchronizer 122 can receive the first information 172, the second information 174, other information based on sensor data, or a combination thereof. The other information may include third information 176 based on sensor data from one or more sensors of the audio playback device 150, such as IMU data (from an IMU sensor), position information that includes or is generated based on position data (from a position sensor), image information that includes or is generated based on image data (from a camera), signal strength information that includes or is generated based on signal strength data (e.g., BT received signal strength indicator (RSSI) data), or a combination thereof. The information (based on different sensors) received by the synchronizer 122 can have different data/frame rates. To illustrate, the first information 172 (generated based on the first sensor data of the first sensor 112) may have a data/frame rate that corresponds to a data/frame sampling rate of the first sensor 112 to generate the first sensor data. The second information 174 (generated based on the second data of the second sensor 114) may be a data/frame rate that corresponds to a data/frame sampling rate of the second sensor 114 to generate the second sensor data. The synchronizer 122 can synchronize the received information in the time domain to generate synchronized information 180 having a common frame rate—e.g., the synchronized information 180 is the information received by the synchronizer and which has been time synchronized to a common frame rate. The synchronized information 180 may be provided to the selector 124. In some implementations, information (e.g., the first information 172, the second information 174, the third information 174, the position information, the image information, or the signal strength information) received by the estimator 120 may include a sensor ID of a sensor that generated sensor data from which the information is determined.

In some examples, the synchronizer 122 receives and synchronizes the first information 172, the second information 174, and the third information 176. In other examples, the synchronizer 122 receives and synchronizes the first information 172 and the third information 176. In yet another example, the synchronizer 122 receives and synchronizes the first information 172 and the second information 174.

The selector 124 is configured to select or generate a determination scheme 182 based on synchronized information 188 associated with one or more sensor outputs. For example, the selector 124 can select or generate the determination scheme 182 based on the first information 172, the second information 174, other information (e.g., the third information 176), or a combination thereof. In the example depicted in FIG. 1, the selector 124 selects the determination scheme 182 based on the synchronized information 180, which is based on the first information 172, the second information 174, other information (e.g., the third information 176), or a combination thereof. In some implementations, the selector 124 may use a model (e.g., a trained machine learning model) that receives the information (e.g., the first information 172, the second information 174, other information (e.g., the third information 176), or a combination thereof) as inputs and that outputs the determination scheme 182.

According to some aspects, the selector 124 is configured to determine which one or more sensors are to be used for by the determiner 126 to determine an orientation 184 associated with the user (or the audio output device 150), a position 186 of the user, or both—e.g., a relative orientation and position estimation, which is relative to the orientation and position of the source device 102. As an example of the determination process, the selector 124 may determine whether or not any portion (e.g., an orientation) of the information (e.g., the synchronized information 180) received by the selector 124 is based on sensor data from an IMU. If no portion of the information (e.g., the synchronized information 180) is based on sensor data from an IMU, the selector 124 selects (or sets) the determination scheme 182 to indicate to use the first information 172 (e.g., a CV output from the image unit 140 that indicates an orientation of the user, a position of the user, or both)—e.g., information based on the first sensor 112 (e.g., a camera). Additionally, or alternatively, the selector 124 may determine whether or not any portion (e.g., an orientation, a position, metadata) of the information (e.g., the synchronized information 180) received by the selector 124 is based on sensor data from a camera. If no information is based on sensor data from a camera, the selector 124 selects (or sets) the determination scheme 182 to indicate to use IMU data to determine an orientation of the user.

As another example of the determination process, if the selector 124 determines that that the selector 124 (e.g., the processor 108) has received information (e.g., the synchronized information 180) includes a portion based on IMU data and a portion based on image data, the selector 124 may select (or set) the determination scheme 182 based on an optimal combination of sensors. For example, the selector 124 may determine weights to be applied to different parts of the synchronized information 180 based on the underlying sensor (e.g., as indicated by a sensor ID) from which a respective part is generated. To illustrate, if the first information 172 indicates that the user is in a field of view of a camera and has a head rotation that is within a range of +/−90 degrees of facing the camera (e.g., the user is at least partially facing the camera), the selector 124 may more heavily weight the first information 172 (e.g., the first sensor 12) which is associated with CV face-tracking performed by the image unit 140 and which has lower motion-to-sound latency than the third information 176 from the third sensor 162 of the audio output device 150. As another example, if the first information 172 indicates that the user is in the field of view of the camera and has a head rotation that is outside of the range of +/−90 degrees of facing the camera (e.g., the user is facing away from the camera), the selector 124 may determine that CV face-tracking will lose acuity and IMU data (e.g., the second information 174 or the third information 176) is more heavily weighted than the first information 172. As another example, if the user is partially or fully out of the field of view of the camera, a view of the user is obstructed, or there is low light in an area of the user, the selector 124 may more heavily weight the IMU data (e.g., the second information 174 or the third information 176) as compared to the first information 172 for purposes of determining an orientation of the user. As another example, if a change in the orientation of the source device 102 is detected based on the second information 174, the orientation of user may be difficult to compute using IMU data and the first information 172 (e.g., CV face-tracking information) is more heavily weighted. In some such examples, to more heavily weight the first information 172, the change in the orientation of the source device 102 is greater than or equal to a threshold amount of change, or a rate of change of the orientation is greater than or equal to a threshold rate of change. In another example, if image information is received from two different cameras, the selector 124 may apply a larger weight to image information from the camera that has better quality metrics, better confidence metrics, a higher resolution, or a combination thereof. It is noted that although the above examples have been described with reference to IMU data (e.g., the second information 174 and the third information 176) and image data or CV data (e.g., the first information 172), the selector 124 may additionally or alternatively consider other data, such as sensor data from a position sensor, sensor data that indicates BT RSSI, or a combination thereof, as illustrative, non-limiting examples.

The determiner 126 is configured to generate or determine the orientation 184, the position 186, or a combination thereof, based on the determination scheme 182. The orientation 184 may be associated with the audio output device 150, the user of the audio output device 150, or a combination thereof. The position 186 may be associated with the audio output device 150, the user of the audio output device 150, or a combination thereof. In some examples, the determiner 126 is configured to determine a pose (e.g., the orientation 184 and the position 186) of the audio output device 150 or the user of the audio output device 150. The orientation 184 may be determined with respect to an orientation of the source device 102 and may include a relative orientation or a relative orientation estimate (of the audio output device 150 or the user of the audio output device 150). The position 186 may be determined with respect to a position of the source device 102 and may include a relative position or a relative position estimate (of the audio output device 150 or the user of the audio output device 150).

In some implementations, the processor 108 (e.g., the determiner 126) determines the orientation 184 and the position 186 as a final relative orientation and a final relative position, respectively, of the user (or of the audio output device 150). The orientation 184 and the position 186 may be determined based on or using the first information 172, the second information 174, the third information 176, the synchronized information 180, other information (e.g., sensor data or metadata), or a combination thereof, received by the processor 108. The processor 108 is configured to provide the orientation 184 and the position 186 to the audio unit 130 (e.g., the spatial audio renderer 132).

In some implementations, the estimator 120 (e.g., the synchronizer 122, the selector 124, the determiner 126, or a combination thereof) is configured to perform multi-modal sensor fusion to combine CV algorithm(s) (e.g., data generated by the CV algorithm(s)) and other sensor data, such as IMU-based orientation information of the source device 102 or the audio playback device 150, for accurate six degrees of freedom (DoF) tracking of a relative position and a relative orientation of a user for dynamic spatial audio rendering associated with the user or an audio output device of the user. The determination scheme 182 output by the selector 124 enables weighted fusion of face-tracking and IMU orientation/position data which can improve overall tracking quality. For example, the CV face-tracking can improve IMU pose prediction quality as the CV face-tracking may have a lower motion-to-sound (M2S)-latency. Additionally, a 360-degree accuracy of IMU tracking can improve, or fill in gaps of, CV face-tracking in at least some conditions. Accordingly, if data frames (e.g., time synchronized data) are dropped or missing from one or more sensors, the processor 108 (e.g., determiner 126) can utilize data from another remaining sensor to compensate for the missing data. For example, the third information 176 may experience packet loss as a result of wireless communication, and thus the determiner 126 can determine the orientation 184, the position 186, or both, based on data that is generated at the source device 102, such as the first information 172 or the second information 174.

The audio unit 130 includes a spatial audio renderer 132. The audio unit 130 is configured to receive the orientation 184, the position 186, or a combination thereof, from the estimator 120 (e.g., from the determiner 126). In some examples, the audio unit 130 is configured to receive the multi-channel audio content 116 for use in rendering spatial audio. The spatial audio renderer 132 is configured to generate a spatial audio output 188 based on the multi-channel audio content 116 and based on the orientation 184, the position 186, or a combination thereof. For example, the spatial audio output 188 may be rendered such that the user perceives the audio as coming from a sound source having a location relative to the user that is based on the orientation 184, the position 186, or a combination thereof. The spatial audio renderer 132 may generate the spatial audio output 188 for playback by the audio output device 150—e.g., the spatial audio output 188 for the user of the audio output device 150. For example, the spatial audio output 188 may be provided to the audio output device 150 via the communication interface 110.

The audio output device 150 may include an audio playback device (e.g., a sink device) of a user. For example, the audio output device 150 may include a headset or earbuds, as illustrative, non-limiting examples. The audio output device 150 includes a memory 156, one or more processors (referred to herein collectively as a “processor 158”), a communication interface 160, a third sensor 162, and a speaker 163. In some examples, the memory 156 further includes instructions that, when executed by the processor 158, cause the processor 158 to perform one or more operations as described herein.

The third sensor 162 is or includes an IMU. Although the audio output device 150 is described as including the third sensor 162, in other examples, the audio output device 150 may include a different sensor than the third sensor 162 or another sensor in addition to the third sensor 162. Additionally, or alternatively, the third sensor 162 may be external to the audio playback device 150 and coupled to the audio playback device 150.

The processor 158 includes an orientation estimator 164. The orientation estimator 164, or a portion thereof, may be implemented by the processor 158 executing instructions (e.g., software), dedicated hardware (e.g., circuitry), or a combination thereof. The orientation estimator 164 is configured to receive third data (e.g., IMU data) from the third sensor 162. The orientation estimator 164 may determine third information 176 based on the third data. The third information 176 may include or indicate an orientation of the audio output device 150, an orientation of a user of the audio output device 150, a sensor ID of the audio output device 150, or a combination thereof. The orientation of the audio output device 150 or of the user may include a direction (e.g., North, South, East, or West), an angular position, a rotation of an axis (e.g., an x-, y-, or z-axis), or a combination thereof, as illustrative, non-limiting examples.

In some examples, the processor 158 is configured to transmit the third information 176 to the source device 102 via the communication interface 160. Additionally, or alternatively, the processor 158 may be configured to receive the spatial audio output 188 from the source device 102 via the communication interface 160. The processor 158 may provide the spatial audio output 188 to the speaker 163 for playback to the user.

The communication interface 160 is coupled to one or more components of the audio output device 150. For example, the communication interface 160 may be coupled to the memory 156, the processor 158, or a combination thereof. In some examples, the communication interface includes a BT interface, such as a BT A2DP interface), a BT HID interface, a Wi-Fi interface, an IEEE 802.11 interface, a Zigbee interface, another type of wireless interface, or a combination thereof.

The speaker 163 is coupled to the processor 108 and configured to output audio sound. To illustrate, the audio sound output by the speaker 163 may be based on the spatial audio output 188. As an example, the audio sound that is based on the spatial audio output 188 may be perceived by the user as coming from a particular direction or distance due to the spatialized audio rendering, binauralization, or a combination thereof.

During operation of the system 100, the processor 108 of the source device 102 obtains the first information 172, which is based on first sensor data from the first sensor 112. The first sensor data may include image data that represents an image, such as an image of the user or an image of the audio output device 150. In some examples, to obtain the first information 172, the processor 108 obtains the first sensor data and detects, based on the first sensor data, a user (e.g., a user of the audio output device 150) included in the image. Based on the first sensor data and the detected user, the processor 108 generates the first information 172 that includes or indicates a user position estimate of the user, a user orientation estimate of the user, metadata, or a combination thereof.

The processor 108 also obtains additional information, such as the second information 174, the third information 176, or both. For example, the processor 108 may obtain the second information 174, which is based on second sensor data from the second sensor 114. For example, the processor 108 may generate the second information 174 based on data from an IMU of the source device 102 that indicates a position of the source device 102, an orientation of the source device 102, or both. Additionally, or alternatively, the processor 108 obtains the third information 176, which is based on third sensor data from the third sensor 162 of the audio output device 150. For example, the processor 108 may receive the third information 176 that is based on data from an IMU of the audio output device 150 that indicates a position of the audio output device 150, an orientation of the audio output device 150, or both.

In implementations, the processor 108 (e.g., the synchronizer 122) synchronizes, in a time domain, the first information 172, the second information 174, the third information 176, or a combination thereof, obtained by the processor 108 to generate the time synchronized information 180. To illustrate, the processor 108 may obtain and synchronize the first information 172, the second information 174, the third information 176, or a combination thereof, in the time domain. In some examples, the processor 108 may obtain and synchronize the first information 172 and the second information 174 in the time domain. In other example, the processor 108 may obtain and synchronize the first information 172 and the third information 176, in the time domain.

The processor 108 selects, based on the first information 172, the second information 174, the third information 176, or a combination thereof, the determination scheme 182. In some examples, the first information 172, the second information 174, the third information 176, or a combination thereof, is time synchronized by the synchronizer 122 to generate the synchronized information 180, and the determination scheme 182 is determined based on the synchronized information 180. The determination scheme 182 may be selected or determined based on whether the first information 172 indicates that the user is facing the first sensor 112, whether the second information 174 indicates that the source device 102 has moved, or based on other considerations, as in the above-described examples of the determination process.

In some examples, the determination scheme 182 indicates one or more weight values, such as a first weight value associated with the first sensor 112 or the first information 172, a second weight value associated with the second sensor 114 or the second information 174, or a third weight value associated with the third sensor 162 or the third information 176. In some examples, to determine the one or more weight values, the processor 108 identifies one or more conditions. For example, the one or more conditions may include an orientation of a representation of the user in the image, whether the user is partially or fully within a field of view of the first sensor, whether the user is obstructed in the field of view of the first sensor, an amount of light associated with the user in the image, a change in a source orientation estimate, or a combination thereof.

The processor 108 (e.g., the determiner 126) generates, based on the determination scheme 182, determination information associated with the audio output device 150. For example, the determiner 126 may combine multiple sensor data (e.g., multiple of the first information 172, the second information 174, and the third information 176) or a single type of sensor data, based on the determination scheme 182, to generate the determination information. The determination information indicates the orientation 184 (e.g., a relative orientation estimate with respect to the source device 102) associated with the user of the audio output device 150, the position 186 (e.g., a relative position estimate with respect to the source device 102) associated with the user of the audio output device 150, or a combination thereof. In some examples, the processor 108 applies weight values indicated by the determination scheme 182 to one or more of the first information 172 (generated based on first sensor data from the first sensor 112), the second information 174 (generated based on second sensor data from the second sensor 114), or the third information 176 (generated based on third sensor data from the third sensor 162), to determine the orientation 184, the position 186, or a combination thereof. The determination information (e.g., the orientation 184 and the position 186) output by the determiner 126 enables six DoF audio rendering by the audio unit 130 (e.g., the spatial audio renderer 132) without the need for complicated information generated by expensive specialized hardware, such as other systems that use internal/external sensors, lighthouse tracking, or inside-out tracking, to determine pose information.

The processor 108 (e.g., the spatial audio renderer 132) may generate the spatial audio output 188 based on the determination information (e.g., the orientation 184, the position 186, or a combination thereof) and the multi-channel audio content 116. In some examples, the spatial audio output 188 corresponds to a rendered version of the multi-channel audio content 116 that causes the user of the audio output device 150 to perceive audio output as coming from a particular direction or distance. The processor 108 may transmit the spatial audio output 188 to the audio output device 150 for playback by the audio output device 150.

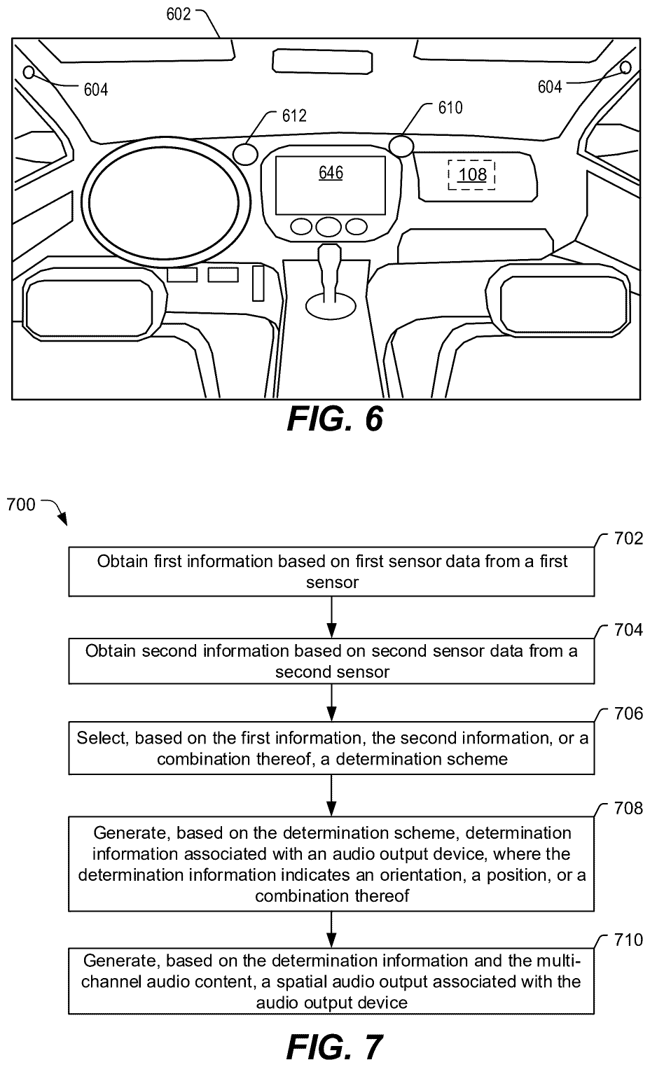

In some examples, the source device 102 corresponds to or is included in one of various types of devices, such that the processor 108 can be integrated in multiple types of devices. In an illustrative example, the processor 108 is integrated in a wearable device, such as a smartwatch as described with reference to FIG. 5, or another wearable device. In another illustrative example, the processor 108 is integrated in a mobile phone or tablet computer device as depicted in FIG. 4, a vehicle as described with reference to FIG. 6, or another system or device.

One technical advantage of implementing the source device 102 as described above is that the source device 102 may utilize the first sensor 112 (e.g., a camera sensor) to provide improved six DoF relative orientation and position estimations for the user of the audio output device 150. For example, the source device 102 may implement multi-modal control logic and sensor fusion to use CV processing along with IMU-based orientation estimation techniques to determine the six DOF relative orientation and position estimations, thereby improving a quality of the spatial audio output 188.

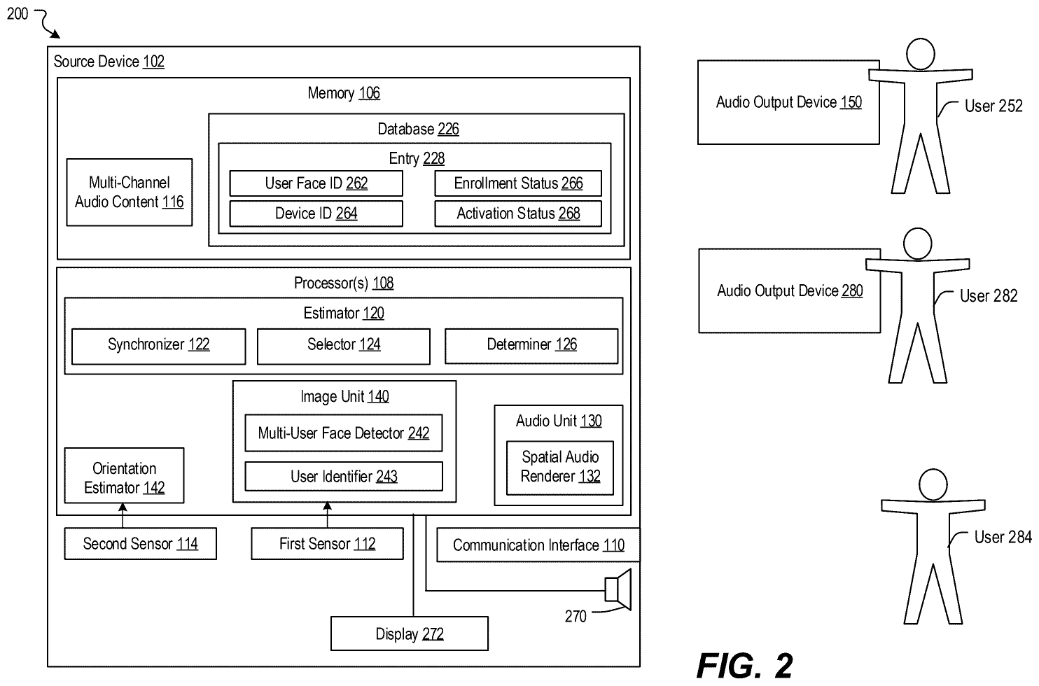

FIG. 2 is a block diagram of an example of a system 200 that includes the device 102 operable to generate spatial audio, in accordance with some examples of the present disclosure. The system 200 may include or correspond to the system 100 with additional audio output devices, and may include one or more components as described above with reference to FIG. 1. The system 200 includes the source device 102, the audio output device 150, and an audio output device 280. The audio output device 280 may include one or more components or be configured to perform one or more operations as described with reference to the audio output device 150 of FIG. 1. In the system 200, the audio output device 150 corresponds to, or is used by, a first user 252 and the audio output device 280 corresponds to, or is used by, a second user 282. In the example shown in FIG. 2, a third user 284 does not have a corresponding audio output device. Although the system 200 is described as including two audio output devices 150 and 280, in other examples, the system 200 may omit all audio output devices or may include a single audio output device or more than two audio output devices.

As compared to the source device 102 of FIG. 1, the source device 102 of FIG. 2 further includes a database 226 stored at the memory 106, a multi-user face detector 242 and a user identifier 243 included in the image unit 140, a speaker 270, and a display 272. Although the source device 102 is described as including the database 226, the multi-user face detector 242, the user identifier 243, the speaker 270, and the display 272 in the source device 102, in other examples, the source device 102 may not include the database 226, the multi-user face detector 242, the user identifier 243, the speaker 270, the display 272, or a combination thereof.

The speaker 270 is coupled to the processor 108 and configured to output audio, such as a spatial audio output rendered by the spatial audio renderer 132. In some examples, the speaker 270 is configured to output audio to a user that does not have a corresponding audio output device (e.g., the audio output device 150 or 280), such as the user 284. The speaker 270 may include a single speaker, multiple speakers, a speaker array, or a sound bar. Additionally, the speaker 270 may be configured to steer one or more audio outputs. Although the speaker 270 is described as being included in the source device 102, in other examples, the speaker 270 may be external to the source device 102 and remotely positioned or otherwise coupled to the source device 102.

The display 272 is coupled to the processor 108 and configured to output video content, such as video content associated with the multi-channel audio content 116. Although the display 272 is described as being included in the source device 102, in other examples, the display 272 may be external to the source device 102 and remotely positioned or otherwise coupled to the source device 102.

Referring to the image unit 140, the multi-user face detector 242 is configured to detect and track one or more users in image data (e.g., first data) from the first sensor 112 (e.g., a camera). For example, the one or more users may be positioned, at least partially, within a field of view of the first sensor 112. The user identifier 243 is configured to identify a user ID of a user detected by the multi-user face detector 242. For example, the user identifier 243 may access the database 226 to identify the user ID associated with the detected user.

Referring to the memory 106, the database 226 includes one or more entries, such as a representative entry 228, that each correspond to a respective user. For example, a first entry may include or correspond to the first user 252, a second entry may include or correspond to the second user 282, and a third entry may include or correspond to the third user 284.

Each entry of the one or more entries may include one or more fields of information. To illustrate, the entry 228 includes or indicates a user face ID 262, a device ID 264, an enrollment status 266, and an activation status 268. In is noted that the one or more fields described with reference to the entry 228 are illustrative and the one or more fields may include additional fields, fewer fields, alternative fields, or a combination thereof, in other examples.

The user face ID 262 includes or indicates a unique ID of a user associated with the entry 228. For example, the unique ID may include an alpha-numeric value, biometric data (e.g., an encoded feature vector), or a combination thereof, that is unique to the respective user. The user face ID 262, or additional information in the entry 228, may also include image data representing an image of the respective user's face or other image data that corresponds to the user and that can be identified in image data (e.g., the first information 172). The device ID 264 includes or indicates a unique ID associated with an audio output device that corresponds to or is paired with the user associated with the entry 228.

The enrollment status 266 indicates whether the user associated with the entry 228 is enrolled in user detection, user identification, user tracking, or a combination thereof, performed by the processor 108 (e.g., the image unit 140). In some examples, the user may be provided an opportunity to opt-in or opt-out of detection, identification, or tracking when registering an audio output device with the source device 102 for spatial audio playback. If the user opts out, the face of the user may be filtered or removed from the image data (e.g., first data from the first sensor 112) by the image unit 140. Accordingly, the enrollment status 266 may provide a level of security or privacy to users that do not enroll with the source device 102.

The activation status 268 may indicate whether or not the user associated with the entry 228 is to receive rendered spatial audio content (e.g., from the audio unit 130). In some examples, a value of the activation status 268 may be set by an operator of the source device 102. For example, the source device 102 may be used in a social scenario (e.g., group gaming or media content viewing), and an operator of the source device 102 may set the activation status such that users playing the game are eligible to receive spatial audio content (from the source device 102) and users who are not playing the game do not receive the spatial audio content.

During operation of the system 200 of FIG. 2, the processor 108 of the source device 102 obtains first sensor data (e.g., image data) from the first sensor 112. The processor 108 (e.g., the image unit 140) may detect, based on the first sensor data, one or more users (e.g., one or more individuals) included in an image corresponding to the image data. For example, the processor 108 (e.g., the multi-user face detector 242) may detect the first user 252, the second user 282, and the third user 284 by performing facial recognition operation(s) on the image data to recognize one or more faces that correspond to the first user 252, the second user 282, the third user 284, or a combination thereof.

For each person detected by the processor 108, the processor 108 (e.g., the user identifier 243) may perform face detection operation(s) on the image data to detect a face of the identified person (e.g., a possible user) for use in matching the face to one of the entries in the database 226. For example, the processor 108 may detect a face and generate an encoded feature vector based on the face to be matched to one or more user face IDs of the database 226, such as the user face ID 262.

In the event of a match between the detected face and a face ID, the processor 108 may retrieve and review an entry of the database 226 that includes the matching user face ID. Using the retrieved entry, the processor 108 determines additional information corresponding to the user associated with the retrieved entry. For example, upon matching a detected face to the entry 228, the processor 108 may associate the detected user, as indicated by the user face ID 262, with the device ID 264, the enrollment status 266, the activation status 268, or a combination thereof.

In some examples, the processor 108 matches a first entry corresponding the first user 252 with a first detected face in the image data from the first sensor 112. Based on information included in the first entry, the processor 108 identifies the audio output device 150 as corresponding to the first user 252 (e.g., based on the device ID of the first entry). Additionally, the processor 108 may determine that the first user 252 is enrolled based on the enrollment status of the first entry, and the processor 108 may determine that the first user 252 is active based on the activation status of the first entry. In this example, the processor 108 (e.g., the audio unit 130) generates the spatial audio output 188 of FIG. 1 for the first user 252, as described with reference to FIG. 1, and transmits the spatial audio output 188 to the audio output device 150 for playback to the first user 252.

In some examples, the processor 108 matches a second entry corresponding to the second user 282 with a second detected face in the image data from the first sensor 112. Based on information included in the second entry, the processor 108 identifies the audio output device 280 as corresponding to the second user 282 (e.g., based on the device ID of the second entry). Additionally, the processor 108 may determine that the second user 282 is enrolled based on the enrollment status of the second entry, and the processor 108 may determine that the second user 282 is not active based on the activation status of the second entry. Accordingly, in this example, the processor 108 (e.g., the audio unit 130) does not generate a spatial audio output for the second user 282.

In some examples, the processor 108 does not identify a match for the third user 284 with a third detected face in the image data from the first sensor 112. Alternatively, in other examples, the processor 108 matches a third entry corresponding to the third user 284 with a third detected face in the image data from the first sensor 112. In some such examples, based on information included in the third entry, the processor 108 identifies that there is no audio output device that corresponds to the third user 284 (e.g., based on the device ID of the third entry having a null value or an initial value). Additionally, the processor 108 may determine that the third user 284 is not enrolled based on the enrollment status of the third entry. Accordingly, in this example, the processor 108 (e.g., the audio unit 130) does not generate a spatial audio output for the third user 284.

One technical advantage of the source device 102 as described above with reference to FIG. 2 is that the source device 102 may perform multi-user tracking based on an enrollment procedure in which the database 226 is populated to include entries that associate the related user face ID 262 of a user with the device ID 264 of the user, and in some aspects, with a corresponding enrollment status or a corresponding activation status. Because multiple users can be enrolled, and corresponding entries included in the database 226, the database 226 may enable dynamic spatial audio rendering by the source device 102 for gaming, teleconferencing, or media consumption by groups of individuals with individual audio output devices, as illustrative, non-limiting examples.

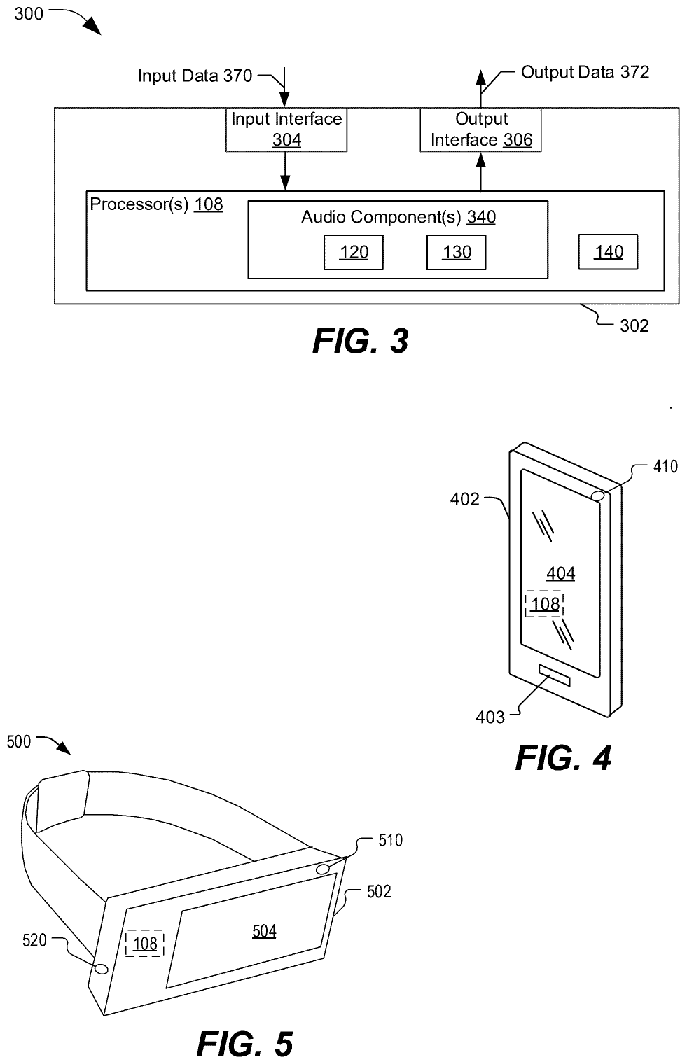

FIG. 3 is a diagram of an example of a system 300 that includes an integrated circuit 302 operable to generate spatial audio, in accordance with some examples of the present disclosure. For example, the spatial audio may include or correspond to the spatial audio output 188. In some implementations, the integrated circuit 302 is configured to be integrated in a device, such as the source device 102.

The integrated circuit 302 includes the processor 108. In some implementations, the integrated circuit 302 also includes a memory (not shown). For example, the memory may include or correspond to the memory 106. The memory may include (e.g., store) sensor data, information (e.g., the first information 172 or the second information 174), the multi-channel audio content 116, the database 226, or a combination thereof.

In FIG. 3, the processor 108 of the integrated circuit 302 includes one or more audio components 340, such as the estimator 120 and the audio unit 130. Optionally, the audio component(s) 340 can include other components as described above with reference to FIGS. 1 and 2. The processor 108 also includes the image unit 140. In some examples, the processor 108 may include one or more video components that include the image unit 140. The audio component(s) 340 and the image unit 140 may be included in the same processor or in different processors.

The integrated circuit 302 also includes an input interface 304, such as one or more bus interfaces, to enable the integrated circuit 302 to receive signals representing input data 370 for processing. For example, the input data 370 can correspond to or include the multi-channel audio content 116, sensor data, information (e.g., the first information 172, the second information 174, the third information 176, etc.), or a combination thereof, as illustrative, non-limiting examples.

The integrated circuit 302 also includes an output interface 306, such as a bus interface, to enable the integrated circuit 302 to output signals representing output data 372. For example, the output data 372 can correspond to or include the orientation 184, the position 186, the spatial audio output 188, or a combination thereof. In some implementations, the output data 372 may be sent to the audio output device 150 or 280, to the speaker 270, or to the display 272.

The integrated circuit 302 enables generation of spatial audio and can be included as a component in a system or device. For example, the system or the device may include a mobile device (e.g., a mobile phone or tablet) as depicted in FIG. 4, a wearable electronic device as depicted in FIG. 5, a vehicle as depicted in FIG. 6, a gaming system, a television system, or another system.

In some embodiments, the system or the device that includes the integrated circuit 302 also includes or is coupled to an image sensor (e.g., a camera), an input device (e.g., a microphone, a keyboard or touch screen, etc.), a display device, a speaker, a modem, or a combination thereof. For example, the image sensor may include or correspond to the first sensor 112. The display device and speaker may include or correspond to the display 272 and the speaker 270, respectively.

In some embodiments, the system or the device that includes the integrated circuit 302 is operable to obtain the input data 370 that includes sensor data, such as first sensor data from a first sensor (e.g., the first sensor 112) and/or second sensor data from a second sensor (e.g., the second sensor 114). Based on the sensor data, the integrated circuit 302 obtains information, such as the first information 172 and/or the second information 174. Based on the information (e.g., the first information 172 and/or the second information 174), the integrated circuit 302, such as the processor 108, relative orientation and position estimations for the user of an audio output device, such as the audio output device 150. For example, the estimator 120 may determine the orientation 184 and the position 186 based on the information. Based on the orientation and the position estimations, the integrated circuit 302 (e.g., the audio unit 130) generates a spatial audio output, such as the spatial audio output 188, that is provided to the output data to the audio output device.

FIG. 4 depicts a diagram of a mobile device 402 operable to generate spatial audio, in accordance with some examples of the present disclosure. The mobile device 402 may include or correspond to a phone or a tablet, as illustrative, non-limiting examples. The mobile device 402 includes a camera 410 (e.g., an image sensor), a display 404 (e.g., a display screen), a microphone 403, and the processor 108. Components of the processor 108 are integrated in the mobile device 402 and are illustrated using dashed lines to indicate internal components that are not generally visible to a user of the mobile device 402. The mobile device 402 may also include a speaker, such as the speaker 270. In some implementations, the mobile device 402 includes the integrated circuit 302 and the processor 108 is included in the integrated circuit 302.

FIG. 5 depicts a diagram of a wearable electronic device 502 operable to generate spatial audio, in accordance with some examples of the present disclosure. The wearable electronic device 502 may include or correspond to a “smart watch,” as an illustrative, non-limiting example. The wearable electronic device 805 includes a camera 510 (e.g., an image sensor), a display 504 (e.g., a display screen), a microphone 520, and the processor 108. Components of the processor 108 are integrated in the wearable electronic device 502 and are illustrated using dashed lines to indicate internal components that are not generally visible to a user of the wearable electronic device 502. The wearable electronic device 502 may also include a speaker, such as the speaker 270. In some implementations, the wearable electronic device 502 includes the integrated circuit 302 and the processor 108 is included in the integrated circuit 302.

FIG. 6 is a diagram of a second example of a vehicle 602 operable to generate spatial audio, in accordance with some examples of the present disclosure. The vehicle 602 may include or correspond to a car, such as an electric car. Although the vehicle 602 is depicted as a car, in other examples, the vehicle 602 may be another type of vehicle, such as an aerial vehicle (e.g., an airplane). The vehicle 602 includes a camera 610 (e.g., an image sensor), a display 646 (e.g., a display screen), a microphone 604, one or more speakers 612, and the processor 108. The microphones 604 are positioned to capture utterances of an operator and/or one or more users of the vehicle 602. In some examples, the speaker 612, at least one of the microphones 604, or both, may be incorporated into a seat of the vehicle 602. Components of the processor 108 are integrated in the vehicle 602 and are illustrated using dashed lines to indicate internal components that are not generally visible to a user of the vehicle 602. In some implementations, the vehicle 602 includes the integrated circuit 302 and the processor 108 is included in the integrated circuit 302.

Each of the mobile device 402, the wearable electronic device 502, and the vehicle 602 includes or corresponds to the source device 102. In some examples, each of the cameras 410, 510, and 610 include or correspond to the first sensor 112. Additionally, the processor 108 may include the audio component(s) 340 (e.g., the estimator 120 and the audio unit 130) and the image unit 140, as described with reference to FIG. 3.

In some embodiments, any of the devices of FIGS. 4-6 is operable to obtain sensor data, such as first sensor data from a first sensor (e.g., the first sensor 112) and/or second sensor data from a second sensor (e.g., the second sensor 114). Based on the sensor data, the processor 108 obtains information, such as the first information 172 and/or the second information 174. Based on the information (e.g., the first information 172 and/or the second information 174), the processor 108 obtains relative orientation and position estimations for the user of an audio output device, such as the audio output device 150. For example, the estimator 120 of the processor 108 may determine the orientation 184 and the position 186 based on the information. Based on the orientation and the position estimations, the processor 108 (e.g., the audio unit 130) generates a spatial audio output, such as the spatial audio output 188, that is provided to the output data to the audio output device.

FIG. 7 is a diagram of a particular illustrative example of a method 700 of generating spatial audio content, in accordance with some examples of the present disclosure. The method 700 may be performed by the source device 102 or another device, such as a mobile device 402, the wearable device 502, the vehicle 602, a gaming device, a television device, a video conference device, a virtual reality (VR) device, an augmented reality (AR) device, an extended reality (XR) device, or another device, as illustrative, non-limiting examples. In a particular aspect, one or more operations of the method 700 are performed by the source device 102, the processor 108, the estimator 120, the synchronizer 122, the selector 124, the determiner 126, the audio unit 130, the spatial audio renderer 132, the image unit 140, the audio component(s) 340, or a combination thereof.

The method 700 includes, at block 702, obtaining, at a source device, first information based on first sensor data from a first sensor. For example, the first information and the first sensor may include or correspond to the first information 172 and the first sensor 112, respectively. The source device may include or correspond to the source device 102.

In some implementations, the first sensor includes an image capture device. Additionally, or alternatively, the first sensor data may include image data. The first information can include a user position estimate of a user of the audio output device, a user orientation estimate of the user of the audio output device, metadata associated with the first sensor data, or a combination thereof. The user position estimate and the user orientation estimate may include or correspond to the position 186 and the orientation 184, respectively.

In some implementations, the method 700 includes obtaining the first sensor data. The method 700 can also include detecting, based on the first sensor data, the user included in an image represented by the first sensor data. Additionally, or alternatively, the method 700 may include determining, based on the first sensor data, the user position estimate of the user of the audio output device, the user orientation estimate of the user of the audio output device, or a combination thereof. In some implementations, the 700 also includes performing, based on the first sensor data, face detection on the image to detect a face of the user included in the image. The method 700 can also include identifying a user ID of the user based on the detected face and, optionally, identifying a device ID of the audio output device based on the user ID. The user ID and the device ID may include or correspond to the user face ID 262 and the device ID 264, respectively.

At block 704, the method 700 includes obtaining second information based on second sensor data from a second sensor. For example, the second information and the second sensor may include or correspond to the second information 174 and the second sensor 114, respectively. As another example, the second information and the second sensor may include or correspond to the third information 176 and the third sensor 162, respectively. In some implementations, the second sensor includes an inertial measurement unit (IMU). Additionally, or alternatively, the second sensor data includes IMU data.

At block 706, the method 700 includes selecting, based on the first information, the second information, or a combination thereof, a determination scheme. For example, the determination scheme may include or correspond to the determination scheme 182. In some implementations, the determination scheme may be selected by the selector 124.

In some implementations, selecting the determination scheme includes identifying one or more conditions. For example, the one or more conditions may include an orientation of a representation of the user in the image, whether the user is partially or fully within a field of view of the first sensor, whether the user is obstructed in the field of view of the first sensor, an amount of light associated with the user in the image, a change in a source orientation estimate, or a combination thereof. The method 700 can also include selecting the determination scheme based on the one or more conditions.

At block 708, the method 700 includes generating, based on the determination scheme, determination information associated with an audio output device. The determination information indicates an orientation, a position, or a combination thereof. For example, the determination information may include or correspond to the orientation 184, the position 186, or a combination thereof.

At block 710, the method 700 includes generating, based on the determination information and multi-channel audio content, a spatial audio output associated with the audio output device. For example, the multi-channel audio content may include or correspond to the multi-channel audio content 116. Additionally, the spatial audio output and the audio output device may include or correspond to the spatial audio output 188 and the audio output device 150, respectively. In some implementations, the method includes transmitting the spatial audio output to the audio output device.

In some implementations, the source device includes a memory and one or more processors. For example, the memory and the one or more processors may include or correspond to the memory 106 and the processor 108, respectively. In some such implementations, the source device includes the first sensor. Additionally, or alternatively, the source device can include the second sensor, and the second information can include a source orientation estimate of the source device.

In some implementations, the method 700 includes obtaining third information based on third sensor data from a third sensor of the audio output device. For example, the third sensor and the third information may include or correspond to the third sensor 162 and the third information 176, respectively. The third sensor may include an IMU and the third sensor data may include IMU data. Additionally, or alternatively, the third information can indicate a user orientation estimate of the user of the audio output device.

In some implementations, the method 700 includes synchronizing the first information, the second information, the third information, or a combination thereof, in a time domain. For example, the synchronizer 122 may synchronize the first information, the second information, the third information, or a combination thereof. In some such implementations, selecting the determination scheme includes, for each of the first information, the second information, the third information, or a combination thereof, determining one or more respective weight values associated with the respective information.

In some implementations, the method 700 includes obtaining fourth information based on fourth sensor data from a fourth sensor. The fourth sensor can include an image capture device. In some such implementations, each of the first sensor and the fourth sensor include a respective image capture device. Additionally, or alternatively, the method 700 may include obtaining fifth information based on fifth sensor data from a fifth sensor associated with the user of the audio output device. For example, the fifth sensor may be included or incorporated in the audio device or another device, such as a mobile device or a wearable device of the user. The fifth information may indicate a position estimate associated with the fifth sensor.

In some implementations, the method 700 includes storing, at a memory, a database that includes one or more entries. The memory and the database may include or correspond to the memory 106 and the database 226. Each entry of the one or more entries may include user ID information including biometric information, audio output device ID information, face tracking enrollment status information, activation status information, or a combination thereof. For example, the biometric information, the audio output device ID information, the face tracking enrollment status information, and the activation status information may include or correspond to the user face ID 262, the device ID 264, the enrollment status 266, and the activation status 268. In some implementations, the method 700 includes determining the audio output device ID information associated with the audio output device based on a communication received from the audio output device. The method 700 can include identifying an entry of the one or more entries based on the audio output device ID information. Additionally, the method 700 may include determining, based on the entry, the user ID information, the face tracking enrollment status information, the activation status information, or a combination thereof. In some such implementations, the method 700 includes performing image processing on the first data based on the user ID information, the face tracking enrollment status information, or the activation status information.

In some implementations, the method 700 includes obtaining sixth information based on sixth sensor data from a sixth sensor of another audio output device associated with another user. For example, the other audio output device and the other user include or correspond to the audio output device 280 and the user 282. The method 700 may include selecting, based on the first information, the second information, the sixth information, or a combination thereof, another determination scheme. The other determination scheme may include or correspond to the determination scheme 182. In some implementations, the method 700 includes generating, based on the other determination scheme, other determination information associated with the other audio output device, and generating, based on the other determination information and the multi-channel audio content, another spatial audio output associated with the other audio output device.

In some implementations, the method 700 includes receiving, via a modem, the multi-channel audio content. For example, the modem may include or correspond to the communication interface 110. In some such implementations, the audio output device includes a headset device. The headset device can include a speaker configured to output the spatial audio output. For example, the speaker may include or correspond to the speaker 270. In some implementations, the source device is integrated in a mobile phone, a tablet computer device, or a wearable electronic device. Alternatively, the source device can be integrated in a vehicle. For example, the vehicle includes the first sensor, the second sensor, or a combination thereof.

In some implantations, the method 700 includes generating video content, and transmitting the video content to a display device. For example, the display device may include or correspond to the display 272.

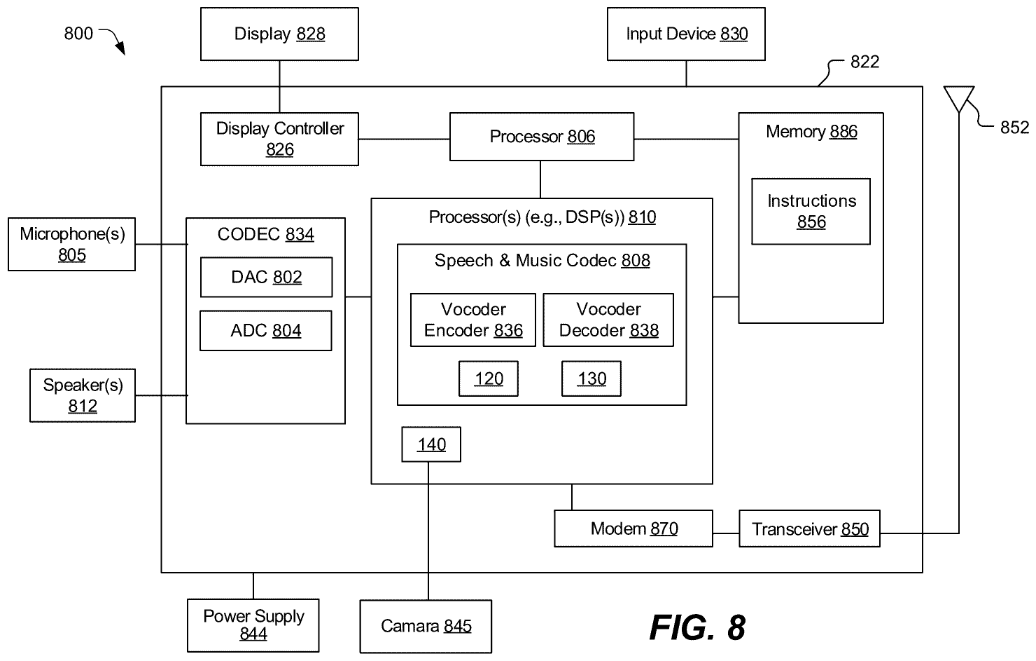

The method 700 of FIG. 7 may be implemented by a field-programmable gate array (FPGA) device, an application-specific integrated circuit (ASIC), a processing unit such as a central processing unit (CPU), a DSP, a controller, another hardware device, firmware device, or any combination thereof. As an example, the method 700 of FIG. 7 may be performed by one or more processors that execute instructions, such as described with reference to FIG. 8.

It is noted that one or more blocks (or operations) described with reference to FIG. 7 may be combined with one or more blocks (or operations) described with reference to another of the figures. For example, one or more blocks associated with FIG. 7 may be combined with one or more blocks (or operations) associated with FIGS. 1-6. Additionally, or alternatively, one or more operations described above with reference to FIGS. 1-7 may be combined with one or more operations described with reference to FIG. 8.

Referring to FIG. 8, a block diagram of a particular illustrative example of a device 800 is depicted. According to various aspects, the device 800 may have more or fewer components than illustrated in FIG. 8. In some examples, the device 800 may correspond to the source device 102. In an illustrative example, the device 800 may perform one or more operations described with reference to FIGS. 1-7.

In the example shown in FIG. 8, the device 800 includes a processor 806 (e.g., a central processing unit (CPU)). The device 800 may include one or more additional processors 810 (e.g., one or more DSPs). In a particular aspect, the processor 108 of FIG. 1 corresponds to the processor 806, the processor(s) 810, or a combination thereof. The processor(s) 810 may include a speech and music coder-decoder (CODEC) 808 that includes a voice coder (“vocoder”) encoder 836 and a vocoder decoder 838. The processor(s) 810 and/or the speech and music CODEC 808 also include the estimator 120 and the audio unit 130. The processor(s) 810 may also include the image unit 140. The device 800 may include a camera 845 coupled to the processor(s) 810 (e.g., the image unit 140). The camera 845 may include or correspond to the first sensor 112.

In this context, the term “processor” refers to an integrated circuit consisting of logic cells, interconnects, input/output blocks, clock management components, memory, and optionally other special purpose hardware components, designed to execute instructions and perform various computational tasks. Examples of processors include, without limitation, central processing units (CPUs), digital signal processors (DSPs), neural processing units (NPU), graphics processing units (GPUs), field programmable gate arrays (FPGAs), microcontrollers, quantum processors, coprocessors, vector processors, other similar circuits, and variants and combinations thereof. In some cases, a processor can be integrated with other components, such as communication components, input/output components, etc. to form a system on a chip (SOC) device or a packaged electronic device.

Taking CPUs as a starting point, a CPU typically includes one or more processor cores, each of which includes a complex, interconnected network of transistors and other circuit components defining logic gates, memory elements, etc. A core is responsible for executing instructions to, for example, perform arithmetic and logical operations. Typically, a CPU includes an Arithmetic Logic Unit (ALU) that handles mathematical operations and a Control Unit that generates signals to coordinate the operation of other CPU components, such as to manage operations a fetch-decode-execute cycle.

CPUs and/or individual processor cores generally include local memory circuits, such as registers and cache to temporarily store data during operations. Registers include high-speed, small-sized memory units intimately connected to the logic cells of a CPU. Often registers include transistors arranged as groups of flip-flops, which are configured to store binary data. Caches include fast, on-chip memory circuits used to store frequently accessed data. Caches can be implemented, for example, using Static Random-Access Memory (SRAM) circuits.

Operations of a CPU (e.g., arithmetic operations, logic operations, and flow control operations) are directed by software and firmware. At the lowest level, the CPU includes an instruction set architecture (ISA) that specifies how individual operations are performed using hardware resources (e.g., registers, arithmetic units, etc.). Higher level software and firmware is translated into various combinations of ISA operations to cause the CPU to perform specific higher-level operations. For example, an ISA typically specifies how the hardware components of the CPU move and modify data to perform operations such as addition, multiplication, and subtraction, and high-level software is translated into sets of such operations to accomplish larger tasks, such as adding two columns in a spreadsheet. Generally, a CPU operates on various levels of software, including a kernel, an operating system, applications, and so forth, with each higher level of software generally being more abstracted from the ISA and usually more readily understandable by human users.

GPUs, NPUs, DSPs, microcontrollers, coprocessors, FPGAs, ASICS, and vector processors include components similar to those described above for CPUs. The differences among these various types of processors are generally related to the use of specialized interconnection schemes and ISAs to improve a processor's ability to perform particular types of operations. For example, the logic gates, local memory circuits, and the interconnects therebetween of a GPU are specifically designed to improve parallel processing, sharing of data between processor cores, and vector operations, and the ISA of the GPU may define operations that take advantage of these structures. As another example, ASICs are highly specialized processors that include similar circuitry arranged and interconnected for a particular task, such as encryption or signal processing. As yet another example, FPGAs are programmable devices that include an array of configurable logic blocks (e.g., interconnect sets of transistors and memory elements) that can be configured (often on the fly) to perform customizable logic functions.

In the example illustrated in FIG. 8, the device 800 includes a memory 886 and a CODEC 834. The memory 886 includes (e.g., stores) instructions 856 that are executable by the processor(s) 810 (or the processor 806) to implement the functionality described with reference to the source device 102 of FIG. 1. The memory 886 may include or correspond to the memory 106 of FIG. 1.

In the example illustrated in FIG. 8, the device 800 also includes a modem 870 coupled, via a transceiver 850, to an antenna 852. The modem 870, transceiver 850, and antenna 852 enable the device 800 to exchange data with one or more other devices via wireless communications. For example, the device 800 can generate audio output at one or more speaker(s) 812, such as audio output generated by the device 800 or based on data received via wireless communication with another device. The speaker(s) 812 may include or correspond to the speaker 270. In some examples, the modem 870 is coupled to the processor(s) 810 or the processor 806. The modem 870 may be configured to receive an audio signal from a second device for playback by the device 800 or by another device, such as an audio output device (e.g., the audio output device 150 or 280).

The device 800 may also include a display 828 coupled to a display controller 826. The display 828 may include or correspond to the display 272. The speaker(s) 812 and one or more microphone(s) 805 may be coupled to the CODEC 834. In FIG. 8, the CODEC 834 includes a digital-to-analog converter (DAC) 802 and an analog-to-digital converter (ADC) 804. In a particular example, the CODEC 834 may receive analog signals from the microphone(s) 805, convert the analog signals to digital signals using the ADC 804 and provide the digital signals to the speech and music codec 808. The speech and music codec 808 may process the digital signals.

In a particular example, the speech and music codec 808 may provide digital signals and/or other audio content to the CODEC 834. The CODEC 834 may convert the digital signals to analog signals using the DAC 802 and may provide the analog signals to the speaker(s) 812.

In a particular example, the device 800 may be included in a system-in-package or system-on-chip device 822. In some such examples, the memory 886, the processor 806, the processor(s) 810, the display controller 826, the CODEC 834, and the modem 870 are included in the system-in-package or the system-on-chip device 822. In a particular example, an input device 830 and a power supply 844 are coupled to the system-in-package or the system-on-chip device 822. Moreover, in a particular example, as illustrated in FIG. 8, the display 828, the input device 830, the speaker(s) 812, the microphone(s) 805, the camera 845, the antenna 852, and the power supply 844 are external to the system-in-package or the system-on-chip device 822. In a particular example, each of the display 828, the input device 830, the speaker(s) 812, the microphone(s) 805, the antenna 852, the camera 845, and the power supply 844 may be coupled to a component of the system-in-package or the system-on-chip device 822, such as an interface or a controller.

The device 800 may include a wearable device, such as a wearable mobile communication device, a wearable personal digital assistant, a wearable display device, a wearable gaming system, a wearable music player, a wearable radio, a wearable camera, a wearable navigation device, a headset, a portable electronic device, a wearable computing device, a wearable communication device, or any combination thereof. Additionally, or alternatively, the device 800 may include a system, such as a mobile phone or tablet computer device, a vehicle, or any combination thereof.

In conjunction with the described aspects, an apparatus includes means for obtaining first information based on first sensor data from a first sensor. For example, the means for obtaining the first information can correspond to the source device 102, the processor 108, the synchronizer 122, the selector 124, the determiner 126, the audio components 340, the processor 806, the processor(s) 810, one or more other circuits or components configured to obtain the first information, or any combination thereof.

The apparatus also includes means for obtaining second information based on second sensor data from a second sensor. For example, the means for obtaining the second information can correspond to the source device 102, the processor 108, the synchronizer 122, the selector 124, the determiner 126, the audio components 340, the processor 806, the processor(s) 810, one or more other circuits or components configured to obtain the second information, or any combination thereof.

The apparatus also includes means for selecting, based on the first information, the second information, or a combination thereof, a determination scheme. For example, the means for selecting the determination scheme can correspond to the source device 102, the processor 108, the selector 124, the audio components 340, the processor 806, the processor(s) 810, one or more other circuits or components configured to select the determination scheme, or any combination thereof.

The apparatus also includes means for generating, based on the determination scheme, determination information associated with an audio output device. For example, the means for generating the determination information can correspond to the source device 102, the processor 108, the determiner 126, the audio components 340, the processor 806, the processor(s) 810, one or more other circuits or components configured to generate the determination information, or any combination thereof. The determination information indicates an orientation, a position, or a combination thereof.

The apparatus also includes means for generating, based on the determination information and multi-channel audio content, a spatial audio output associated with the audio output device. For example, the means for generating the spatial audio output can correspond to the source device 102, the processor 108, the audio unit 130, the spatial audio renderer 132, the audio components 340, the processor 806, the processor(s) 810, one or more other circuits or components configured to generate the spatial audio output, or any combination thereof.

In some aspects, a non-transitory computer-readable medium (e.g., a computer-readable storage device, such as the memory 106 or 886) includes instructions (e.g., the instructions 856) that, when executed by one or more processors (e.g., the processor 108, the processor(s) 810, or the processor 806), cause the one or more processors to obtain first information (e.g., the first information 172) based on first sensor data from a first sensor (e.g., the first sensor 112) and to obtain second information (e.g., the second information 174) based on second sensor data from a second sensor (e.g., the second sensor 114). The instructions, when executed by one or more processors, can further cause the one or more processors to select, based on the first information, the second information, or a combination thereof, a determination scheme (e.g., the determination scheme 182). The instructions, when executed by one or more processors, can further cause the one or more processors to generate, based on the determination scheme, determination information (e.g., the orientation 184, the position 186, or both) associated with an audio output device (e.g., the audio output device 150). The determination information indicates an orientation (e.g., the orientation 184), a position (e.g., the position 186), or a combination thereof. The instructions, when executed by one or more processors, can further cause the one or more processors to generate, based on the determination information and multi-channel audio content (e.g., the multi-channel audio content 116), a spatial audio output (e.g., the spatial audio output 188) associated with the audio output device.

Particular aspects of the disclosure are described below in sets of interrelated Examples:

According to Example 1, a device includes a memory configured to store multi-channel audio content; and one or more processors configured to obtain first information based on first sensor data from a first sensor; obtain second information based on second sensor data from a second sensor; select, based on the first information, the second information, or a combination thereof, a determination scheme; generate, based on the determination scheme, determination information associated with an audio output device, where the determination information indicates an orientation, a position, or a combination thereof; and generate, based on the determination information and the multi-channel audio content, a spatial audio output associated with the audio output device.

Example 2 includes the device of Example 1, where the one or more processors are further configured to transmit the spatial audio output to the audio output device.

Example 3 includes the device of Example 1 or Example 2, where: the first sensor includes an image capture device; the first sensor data includes image data; or the first information includes a user position estimate of a user of the audio output device, a user orientation estimate of the user of the audio output device, metadata associated with the first sensor data, or a combination thereof.

Example 4 includes the device of Example 3, where the one or more processors are configured to obtain the first sensor data; detect, based on the first sensor data, the user included in an image represented by the first sensor data; and determine, based on the first sensor data, the user position estimate of the user of the audio output device, the user orientation estimate of the user of the audio output device, or a combination thereof.

Example 5 includes the device of Example 4, where the one or more processors are configured to perform, based on the first sensor data, face detection on the image to detect a face of the user included in the image; identify a user identity (ID) of the user based on the detected face; and identify a device ID of the audio output device based on the user ID.

Example 6 includes the device of any of Examples 1 to 5, where: the second sensor includes an inertial measurement unit (IMU); or the second sensor data includes IMU data.

Example 7 includes the device of any of Examples 1 to 6, where the device is a source device that includes the memory and the one or more processors.

Example 8 includes the device of Example 7, where the source device includes: the first sensor; the second sensor, where the second information includes a source orientation estimate of the source device; or a combination thereof.

Example 9 includes the device of any of Examples 1 to 8, where the one or more processors are further configured to obtain third information based on third sensor data from a third sensor of the audio output device.

Example 10 includes the device of Example 9, where: the third sensor includes another inertial measurement unit (IMU); the third sensor data includes additional IMU data; or the third information indicates another user orientation estimate of the user of the audio output device.

Example 11 includes the device of any of Examples 1 to 10, where the one or more processors are configured to obtain fourth information based on fourth sensor data from a fourth sensor, where the fourth sensor includes another image capture device; obtain fifth information based on fifth sensor data from a fifth sensor associated with the user of the audio output device, where the fifth information indicates a position estimate associated with the fifth sensor; or a combination thereof.

Example 12 includes the device of any of Examples 9 to 11, where the one or more processors are further configured to synchronize the first information, the second information, the third information, or a combination thereof, in a time domain.

Example 13 includes the device of any of Examples 9 to 12, where, to select the determination scheme, the one or more processors are configured to, for each of the first information, the second information, the third information, or a combination thereof, determine one or more respective weight values associated with the respective information.

Example 14 includes the device of any of Examples 1 to 13, where, to select the determination scheme, the one or more processors are configured to identify one or more conditions, where the one or more conditions include: an orientation of a representation of the user in the image; whether the user is partially or fully within a field of view of the first sensor; whether the user is obstructed in the field of view of the first sensor; an amount of light associated with the user in the image; a change in a source orientation estimate; or a combination thereof; and select the determination scheme based on the one or more conditions.

Example 15 includes the device of any of Examples 1 to 14, where: the memory is further configured to store a database that includes one or more entries; and each entry of the one or more entries includes user identity (ID) information including biometric information, audio output device ID information, face tracking enrollment status information, activation status information, or a combination thereof.

Example 16 includes the device of Example 15, where the one or more processors are further configured to determine the audio output device ID information associated with the audio output device based on a communication received from the audio output device; identify an entry of the one or more entries based on the audio output device ID information; determine, based on the entry, the user ID information, the face tracking enrollment status information, the activation status information, or a combination thereof; and perform image processing on the first data based on the user ID information, the face tracking enrollment status information, or the activation status information.

Example 17 includes the device of Example 16, where the one or more processors are further configured to obtain sixth information based on sixth sensor data from a sixth sensor of another audio output device associated with another user; select, based on the first information, the second information, the sixth information, or a combination thereof, another determination scheme; generate, based on the other determination scheme, other determination information associated with the other audio output device; and generate, based on the other determination information and the multi-channel audio content, another spatial audio output associated with the other audio output device.

Example 18 includes the device of any of Examples 1 to 17, further comprising a modem coupled to the one or more processors, the modem configured to receive the multi-channel audio content.

Example 19 includes the device of any of Examples 1 to 18, where: the audio output device includes a headset device that further includes a speaker; and the speaker is configured to output the spatial audio output.

Example 20 includes the device of any of Examples 1 to 19, where the one or more processors are integrated in a mobile phone, a tablet computer device, or a wearable electronic device.

Example 21 includes the device of any of Examples 1 to 19, where the one or more processors are integrated in a vehicle, and the vehicle includes the first sensor, the second sensor, or a combination thereof.

Example 22 includes the device of any of Examples 1 to 21, further includes a display device coupled to the one or more processors; and where the one or more processors are configured to generate video content for display via the display device.

Example 23 includes the device of Example 1, further includes the first sensor, where the first sensor includes a camera, and the first sensor data includes image data; and where: the device is a source device that is distinct from the audio output device; and the second sensor includes an inertial measurement unit (IMU).

Example 24 includes the device of Example 23, further includes the second sensor, where the second information indicates an orientation of the source device.

Example 25 includes the device of Example 23, where: the second sensor is included in the audio output device; and the second information indicates an orientation of the audio output device.

According to Example 26, a method of generating spatial audio content, the method includes obtaining, at a source device, first information based on first sensor data from a first sensor; obtaining second information based on second sensor data from a second sensor; selecting, based on the first information, the second information, or a combination thereof, a determination scheme; generating, based on the determination scheme, determination information associated with an audio output device, where the determination information indicates an orientation, a position, or a combination thereof; and generating, based on the determination information and multi-channel audio content, a spatial audio output associated with the audio output device.

Example 27 includes the method of Example 26, and further includes transmitting the spatial audio output to the audio output device.

Example 28 includes the method of Example 26 or Example 27, where: the first sensor includes an image capture device; the first sensor data includes image data; or the first information includes a user position estimate of a user of the audio output device, a user orientation estimate of the user of the audio output device, metadata associated with the first sensor data, or a combination thereof.

Example 29 includes the method of Example 28, and further includes obtaining the first sensor data; detecting, based on the first sensor data, the user included in an image represented by the first sensor data; and determining, based on the first sensor data, the user position estimate of the user of the audio output device, the user orientation estimate of the user of the audio output device, or a combination thereof.

Example 30 includes the method of Example 29, and further includes performing, based on the first sensor data, face detection on the image to detect a face of the user included in the image; identifying a user identity (ID) of the user based on the detected face; and identifying a device ID of the audio output device based on the user ID.

Example 31 includes the method of any of Examples 26 to 30, where: the second sensor includes an inertial measurement unit (IMU); or the second sensor data includes IMU data.

Example 32 includes the method of any of Examples 26 to 31, where the source device includes a memory and one or more processors.

Example 33 includes the method of any of Examples 26 to 32, where the source device includes: the first sensor; the second sensor, where the second information includes a source orientation estimate of the source device; or a combination thereof.

Example 34 includes the method of any of Examples 26 to 33, and further includes obtaining third information based on third sensor data from a third sensor of the audio output device.

Example 35 includes the method of Example 34, where: the third sensor includes another inertial measurement unit (IMU); the third sensor data includes additional IMU data; or the third information indicates another user orientation estimate of the user of the audio output device.

Example 36 includes the method of any of Examples 26 to 35, and further includes obtaining fourth information based on fourth sensor data from a fourth sensor, where the fourth sensor includes another image capture device; obtaining fifth information based on fifth sensor data from a fifth sensor associated with the user of the audio output device, where the fifth information indicates a position estimate associated with the fifth sensor; or a combination thereof.

Example 37 includes the method of any of Examples 34 to 36, and further includes synchronizing the first information, the second information, the third information, or a combination thereof, in a time domain.

Example 38 includes the method of any of Examples 34 to 37, where selecting the determination scheme includes: for each of the first information, the second information, the third information, or a combination thereof, determining one or more respective weight values associated with the respective information.

Example 39 includes the method of any of Examples 26 to 38, where selecting the determination scheme includes: identifying one or more conditions, where the one or more conditions include: an orientation of a representation of the user in the image; whether the user is partially or fully within a field of view of the first sensor; whether the user is obstructed in the field of view of the first sensor; an amount of light associated with the user in the image; a change in a source orientation estimate; or a combination thereof; and selecting the determination scheme based on the one or more conditions.

Example 40 includes the method of Example 39, where the determination scheme is selected based on the one or more conditions.

Example 41 includes the method of any of Examples 26 to 40, and further includes storing, at a memory, a database that includes one or more entries; and each entry of the one or more entries includes user identity (ID) information including biometric information, audio output device ID information, face tracking enrollment status information, activation status information, or a combination thereof.

Example 42 includes the method of Example 41, and further includes determining the audio output device ID information associated with the audio output device based on a communication received from the audio output device; identifying an entry of the one or more entries based on the audio output device ID information; determining, based on the entry, the user ID information, the face tracking enrollment status information, the activation status information, or a combination thereof; and performing image processing on the first data based on the user ID information, the face tracking enrollment status information, or the activation status information.

Example 43 includes the method of Example 42, and further includes obtaining sixth information based on sixth sensor data from a sixth sensor of another audio output device associated with another user; selecting, based on the first information, the second information, the sixth information, or a combination thereof, another determination scheme; generating, based on the other determination scheme, other determination information associated with the other audio output device; and generating, based on the other determination information and the multi-channel audio content, another spatial audio output associated with the other audio output device.

Example 44 includes the method of any of Examples 26 to 43, and further includes receiving, via a modem, the multi-channel audio content.

Example 45 includes the method of any of Examples 26 to 44, where the audio output device includes a headset device, the headset device includes a speaker configured to output the spatial audio output.

Example 46 includes the method of any of Examples 26 to 45, where the source device is integrated in a mobile phone, a tablet computer device, or a wearable electronic device.

Example 47 includes the method of any of Examples 26 to 45, where the source device is integrated in a vehicle, and the vehicle includes the first sensor, the second sensor, or a combination thereof.

Example 48 includes the method of any of Examples 26 to 47, and further includes generating video content; and transmitting the video content to a display device.

Example 49 includes the method of Example 48, and further includes generating the first information at the first sensor, where the first sensor includes a camera, and the first sensor data includes image data; and where: the source device is distinct from the audio output device; and the second sensor includes an inertial measurement unit (IMU).

Example 50 includes the method of Example 49, and further includes generating the second information at the second sensor, where the second information indicates an orientation of the source device.

Example 51 includes the method of Example 49, where: the second sensor is included in the audio output device; and the second information indicates an orientation of the audio output device.

According to Example 52, a non-transitory computer-readable medium that stores instructions that are executable by one or more processors to cause the one or more processors to obtain first information based on first sensor data from a first sensor; obtain second information based on second sensor data from a second sensor; select, based on the first information, the second information, or a combination thereof, a determination scheme; generate, based on the determination scheme, determination information associated with an audio output device, where the determination information indicates an orientation, a position, or a combination thereof; and generate, based on the determination information and multi-channel audio content, a spatial audio output associated with the audio output device.

Example 53 includes the non-transitory computer-readable medium of Example 52, where the instructions are executable by one or more processors to cause the one or more processors to transmit the spatial audio output to the audio output device.

Example 54 includes the non-transitory computer-readable medium of Example 52 or Example 53, where: the first sensor includes an image capture device; the first sensor data includes image data; or the first information includes a user position estimate of a user of the audio output device, a user orientation estimate of the user of the audio output device, metadata associated with the first sensor data, or a combination thereof.

Example 55 includes the non-transitory computer-readable medium of Example 54, where the instructions are executable by one or more processors to cause the one or more processors to obtain the first sensor data; detect, based on the first sensor data, the user included in an image represented by the first sensor data; and determine, based on the first sensor data, the user position estimate of the user of the audio output device, the user orientation estimate of the user of the audio output device, or a combination thereof.

Example 56 includes the non-transitory computer-readable medium of Example 55, where the instructions are executable by one or more processors to cause the one or more processors to perform, based on the first sensor data, face detection on the image to detect a face of the user included in the image; identify a user identity (ID) of the user based on the detected face; and identify a device ID of the audio output device based on the user ID.

Example 57 includes the non-transitory computer-readable medium of any of Examples 52 to 56, where: the second sensor includes an inertial measurement unit (IMU); or the second sensor data includes IMU data.

Example 58 includes the non-transitory computer-readable medium of any of Examples 52 to 57, where the non-transitory computer-readable medium configured to be integrated in a source device.

Example 59 includes the non-transitory computer-readable medium of Example 58, where the source device includes: the first sensor; the second sensor, where the second information includes a source orientation estimate of the source device; or a combination thereof.

Example 60 includes the non-transitory computer-readable medium of any of Examples 52 to 59, where the instructions are executable by one or more processors to cause the one or more processors to obtain third information based on third sensor data from a third sensor of the audio output device.

Example 61 includes the non-transitory computer-readable medium of Example 60, where: the third sensor includes another inertial measurement unit (IMU); the third sensor data includes additional IMU data; or the third information indicates another user orientation estimate of the user of the audio output device.

Example 62 includes the non-transitory computer-readable medium of any of Examples 52 to 61, where the instructions are executable by one or more processors to cause the one or more processors to obtain fourth information based on fourth sensor data from a fourth sensor, where the fourth sensor includes another image capture device; obtain fifth information based on fifth sensor data from a fifth sensor associated with the user of the audio output device, where the fifth information indicates a position estimate associated with the fifth sensor; or a combination thereof.

Example 63 includes the non-transitory computer-readable medium of any of Examples 60 to 62, where the instructions are executable by one or more processors to cause the one or more processors to synchronize the first information, the second information, the third information, or a combination thereof, in a time domain.

Example 64 includes the non-transitory computer-readable medium of any of Examples 60 to 63, where, to select the determination scheme, the instructions are executable by one or more processors to cause the one or more processors to for each of the first information, the second information, the third information, or a combination thereof, determine one or more respective weight values associated with the respective information.

Example 65 includes the non-transitory computer-readable medium of any of Examples 52 to 64, where, to select the determination scheme, the instructions are executable by one or more processors to cause the one or more processors to identify one or more conditions, where the one or more conditions include: an orientation of a representation of the user in the image; whether the user is partially or fully within a field of view of the first sensor; whether the user is obstructed in the field of view of the first sensor; an amount of light associated with the user in the image; a change in a source orientation estimate; or a combination thereof; and select the determination scheme based on the one or more conditions.

Example 66 includes the non-transitory computer-readable medium of any of Examples 52 to 65, where the instructions are executable by one or more processors to cause the one or more processors to store a database that includes one or more entries; and each entry of the one or more entries includes user identity (ID) information including biometric information, audio output device ID information, face tracking enrollment status information, activation status information, or a combination thereof.

Example 67 includes the non-transitory computer-readable medium of Example 66, where the instructions are executable by one or more processors to cause the one or more processors to determine the audio output device ID information associated with the audio output device based on a communication received from the audio output device; identify an entry of the one or more entries based on the audio output device ID information; determine, based on the entry, the user ID information, the face tracking enrollment status information, the activation status information, or a combination thereof; and perform image processing on the first data based on the user ID information, the face tracking enrollment status information, or the activation status information.

Example 68 includes the non-transitory computer-readable medium of Example 67, where the instructions are executable by one or more processors to cause the one or more processors to obtain sixth information based on sixth sensor data from a sixth sensor of another audio output device associated with another user; select, based on the first information, the second information, the sixth information, or a combination thereof, another determination scheme; generate, based on the other determination scheme, other determination information associated with the other audio output device; and generate, based on the other determination information and the multi-channel audio content, another spatial audio output associated with the other audio output device.

Example 69 includes the non-transitory computer-readable medium of any of Examples 52 to 68, where the instructions are executable by one or more processors to cause the one or more processors to receive, from a modem coupled to the one or more processors, the multi-channel audio content.

Example 70 includes the non-transitory computer-readable medium of any of Examples 52 to 69, where: the audio output device includes a headset device that further includes a speaker; and the speaker is configured to output the spatial audio output.

Example 71 includes the non-transitory computer-readable medium of any of Examples 52 to 70, where the non-transitory computer-readable medium is configured to be integrated in a mobile phone, a tablet computer device, or a wearable electronic device.

Example 72 includes the non-transitory computer-readable medium of any of Examples 52 to 70, where the non-transitory computer-readable medium is configured to be integrated in a vehicle, and the vehicle includes the first sensor, the second sensor, or a combination thereof.

Example 73 includes the non-transitory computer-readable medium of any of Examples 52 to 72, where the instructions are executable by one or more processors to cause the one or more processors to generate video content, and transmit the video content to a display device coupled to the one or more processors.

Example 74 includes the non-transitory computer-readable medium of Example 52, where: the non-transitory computer-readable medium is configured to be integrated in a source device that is distinct from the audio output device, the source device includes the first sensor, the first sensor includes a camera, the first sensor data includes image data, and the second sensor includes an inertial measurement unit (IMU).

Example 75 includes the non-transitory computer-readable medium of Example 74, where the second information indicates an orientation of the source device.

Example 76 includes the non-transitory computer-readable medium of Example 74, where: the second sensor is included in the audio output device; and the second information indicates an orientation of the audio output device.

According to Example 77, a device includes a memory configured to store multi-channel audio content; a first sensor configured to generate first sensor data, where the first sensor includes a camera and the first sensor data include image data; and one or more processors configured to obtain first information based on the first sensor data; obtain second information based on second sensor data from a second sensor, the second sensor includes an inertial measurement unit (IMU) and the second sensor data includes IMU data; select, based on the first information, the second information, or a combination thereof, a determination scheme; generate, based on the determination scheme, determination information associated with an audio output device, where the determination information indicates an orientation, a position, or a combination thereof; and generate, based on the determination information and the multi-channel audio content, a spatial audio output associated with the audio output device.

Example 78 includes the device of Example 77, where: the second sensor is included in the audio output device; and the second information indicates an orientation of the audio output device.

Example 79 includes the device of Example 77, further includes the second sensor, where the second information indicates an orientation of the source device.

Example 80 includes the device of Example 79, where the one or more processors are further configured to obtain, from the audio output device, third information based on third sensor data from a third sensor of the audio output device; and where: the third information indicates an orientation of the audio output device, the third sensor includes an IMU, or a combination thereof.

Those of skill would further appreciate that the various illustrative logical blocks, configurations, modules, circuits, and algorithm steps described in connection with the examples disclosed herein may be implemented as electronic hardware, computer software executed by a processor, or combinations of both. Various illustrative components, blocks, configurations, modules, circuits, and steps have been described above generally in terms of their functionality. Whether such functionality is implemented as hardware or processor executable instructions depends upon the particular application and design constraints imposed on the overall system. Skilled artisans may implement the described functionality in varying ways for each particular application, such implementation decisions are not to be interpreted as causing a departure from the scope of the present disclosure.

The steps of a method or algorithm described in connection with the examples disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of non-transient storage medium known in the art. An exemplary storage medium is coupled to the processor such that the processor may read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory configured to store multi-channel audio content; and
one or more processors configured to:
obtain first information based on first sensor data from a first sensor;
obtain second information based on second sensor data from a second sensor;
select, based on the first information, the second information, or a combination thereof, a determination scheme;
generate, based on the determination scheme, determination information associated with an audio output device, wherein the determination information indicates an orientation, a position, or a combination thereof; and
generate, based on the determination information and the multi-channel audio content, a spatial audio output associated with the audio output device.

2. The device of claim 1, wherein:
the first sensor includes an image capture device,
the first sensor data includes image data, or
the first information includes a user position estimate of a user of the audio output device, a user orientation estimate of the user of the audio output device, metadata associated with the first sensor data, or a combination thereof.

3. The device claim 2, wherein the one or more processors are configured to:
obtain the first sensor data;
detect, based on the first sensor data, the user included in an image represented by the first sensor data; and
determine, based on the first sensor data, the user position estimate of the user of the audio output device, the user orientation estimate of the user of the audio output device, or a combination thereof.

4. The device of claim 1, further comprising:
the first sensor,
wherein the one or more processors are configured to transmit the spatial audio output to the audio output device.

5. The device of claim 4, wherein:
the second sensor includes an inertial measurement unit (IMU); and
the second sensor data includes IMU data.

6. The device of claim 4, wherein:
the second sensor is included in the audio output device; and
the second information indicates an orientation of the audio output device.

7. The device of claim 4, further comprising:
the second sensor, wherein the second information indicates an orientation of the device.

8. The device of claim 7, wherein:
the one or more processors are further configured to obtain third information based on third sensor data from a third sensor of the audio output device,
the third sensor includes another inertial measurement unit (IMU),
the third sensor data includes additional IMU data, and
the third information indicates another user orientation estimate of a user of the audio output device.

9. The device of claim 8, wherein:
the one or more processors are further configured to synchronize the first information, the second information, the third information, or a combination thereof, in a time domain,
to select the determination scheme, the one or more processors are configured to for each of the first information, the second information, the third information, or a combination thereof, determine one or more respective weight values associated with the respective information.

10. The device of claim 1, wherein:
to select the determination scheme, the one or more processors are configured to identify one or more conditions, wherein the one or more conditions include:
an orientation of a representation of a user in an image;
whether the user is partially or fully within a field of view of the first sensor;
whether the user is obstructed in the field of view of the first sensor;
an amount of light associated with the user in the image;
a change in a source orientation estimate; or
a combination thereof; and
the determination scheme is selected based on the one or more conditions.

11. The device of claim 1, wherein the one or more processors are further configured to:
determine audio output device identity (ID) information associated with the audio output device based on a communication received from the audio output device;
identify an entry of one or more entries of a database based on the audio output device ID information, each entry of the one or more entries includes user ID information including biometric information, audio output device ID information, face tracking enrollment status information, activation status information, or a combination thereof;
determine, based on the entry, the user ID information, the face tracking enrollment status information, the activation status information, or a combination thereof; and
perform image processing on the first sensor data based on the user ID information, the face tracking enrollment status information, or the activation status information.

12. The device of claim 1, further comprising a modem coupled to the one or more processors, the modem configured to receive the multi-channel audio content.

13. The device of claim 1, wherein:
the audio output device includes a headset device that further includes a speaker; and
the speaker is configured to output the spatial audio output.

14. The device of claim 1, wherein the one or more processors are integrated in a mobile phone, a tablet computer device, or a wearable electronic device.

15. The device of claim 1, wherein the one or more processors are integrated in a vehicle, and the vehicle includes the first sensor, the second sensor, or a combination thereof.

16. The device of claim 1, further comprising:
a display device coupled to the one or more processors; and
wherein the one or more processors are configured to generate video content for display via the display device.

17. The device of claim 1, further comprising:
the first sensor, wherein the first sensor includes a camera, and the first sensor data includes image data; and
wherein:
the device is a source device that is distinct from the audio output device; and
the second sensor includes an inertial measurement unit (IMU).

18. A method of generating spatial audio content, the method comprising:
obtaining, at a source device, first information based on first sensor data from a first sensor;
obtaining second information based on second sensor data from a second sensor;
selecting, based on the first information, the second information, or a combination thereof, a determination scheme;
generating, based on the determination scheme, determination information associated with an audio output device, wherein the determination information indicates an orientation, a position, or a combination thereof; and
generating, based on the determination information and multi-channel audio content, a spatial audio output associated with the audio output device.

19. The method of claim 18, further comprising:
obtaining third information based on third sensor data from a third sensor of the audio output device,
wherein:
the source device includes the first sensor and the second sensor,
the third sensor includes another inertial measurement unit (IMU), and
the third information indicates another user orientation estimate of a user of the audio output device.

20. A non-transitory computer-readable medium that stores instructions that are executable by one or more processors to cause the one or more processors to:
obtain first information based on first sensor data from a first sensor;
obtain second information based on second sensor data from a second sensor;
select, based on the first information, the second information, or a combination thereof, a determination scheme;
generate, based on the determination scheme, determination information associated with an audio output device, wherein the determination information indicates an orientation, a position, or a combination thereof; and
generate, based on the determination information and multi-channel audio content, a spatial audio output associated with the audio output device.
